(19) United States
(12) Patent Application Publication
(10) Pub. No.: US 2026/0093525 A1
(43) Pub. Date: Apr. 2, 2026

(54) PROCESSOR CACHE ALLOCATION FOR OPTIMIZED TASK EXECUTION

(71) Applicant: NVIDIA Corporation, Santa Clara, CA (US)

(72) Inventor: Mateusz Berezecki, San Francisco, CA (US)

(21) Appl. No.: 18/904,459

(22) Filed: Oct. 2, 2024

(51) Int. Cl. G06F 9/48; G06F 9/30; G06F 12/084

(52) U.S. Cl. CPC G06F 9/4881; G06F 9/30047; G06F 12/084

(57) ABSTRACT

Technologies related to processor cache allocation are described. The present disclosure provides systems and methods that allocate a first portion of a shared processor cache of a multi-core processor for a first task, where additional tasks are restricted from writing to the first portion of the shared processor cache.

### TECHNICAL FIELD

At least one embodiment pertains to processor cache allocation.

### BACKGROUND

A cache is a storage layer that holds data and/or instructions close to a processing unit, significantly reducing the time it takes to retrieve this data. Depending on chip architecture, some chips can hold data and instructions in a cache, while some chips keep data and instructions separate. Caches are typically much faster than general memory (e.g., random access memory (RAM)) but are smaller in size. Caches may be organized in levels (L1, L2, and sometimes L3), with L1 being the smallest and fastest, and each subsequent level being larger and slightly slower. Caches accelerate processing by allowing frequently accessed data to be closer to processing units and more quickly accessible, decreasing the time spent waiting for data to be retrieved from the slower main memory. This leads to faster execution of instructions, improved performance, and overall enhanced system responsiveness.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a computer system, according to one embodiment.

FIG. 2 is a flowchart illustrating a method of exclusively reserving of a portion of a shared processor cache, according to one embodiment.

FIG. 3 illustrates a flow diagram for a method of cache allocation, in accordance with one embodiment.

FIG. 4A illustrates inference and/or training logic, according to at least one embodiment of the present disclosure;

FIG. 4B illustrates inference and/or training logic, according to at least one embodiment;

FIG. 5 illustrates training and deployment of a neural network, according to at least one embodiment;

FIG. 6 is an example data flow diagram for an advanced computing pipeline, according to at least one embodiment;

FIG. 7 is a system diagram for an example system for training, adapting, instantiating and deploying machine learning models in an advanced computing pipeline, according to at least one embodiment.

FIG. 8 illustrates a computer system, according to at least one embodiment.

FIG. 9 illustrates a computer system, according to at least one embodiment.

FIG. 10A is a block diagram of an example generative language model system suitable for use in implementing some embodiments of the present disclosure.

FIG. 10B is a block diagram of an example generative language model that includes a transformer encoder-decoder suitable for use in implementing some embodiments of the present disclosure.

FIG. 10C is a block diagram of an example generative language model that includes a decoder-only transformer architecture suitable for use in implementing some embodiments of the present disclosure.

FIG. 11 is a block diagram of an example computing device suitable for use in implementing some embodiments of the present disclosure.

FIG. 12 is a block diagram of an example data center suitable for use in implementing some embodiments of the present disclosure.

### DETAILED DESCRIPTION

Technologies related to processor cache allocation for optimized task execution are described. Certain programs often rely on loading frequently accessed data onto memory, such as on-chip cache, that has a lower read cost than an original memory location (e.g., such as random-access memory (RAM)). One such example of frequently accessed data may be vector datasets used in Retrieval Augmented Generation (RAG) model applications, which often utilize similarity search techniques that involve processing large amounts of data. As a result, these vector datasets are often loaded into on-chip cache for assessing pairwise similarity between vectors. This type of workload is well-tailored for parallel accelerated computing devices, such as graphic processing units (GPUs). However, for computing devices without an equipped GPU, throughput performance can significantly suffer due to high memory latencies of data retrieval operations between a processor, such as a central processing unit (CPU), and external memory, such as dynamic random-access memory (DRAM). These data retrieval operations between the processor and external memory can sometimes take up to 100-300 clock cycles. Conversely, data retrieval operations between a processor core and a processor cache can take between 10-50 clock cycles. In cases where the processor has multiple cores that share the processor cache, data retrieval operations between the processor and external memory may become more frequent due to cache contention. This can result in some or all of the vector dataset being evicted from the processor cache.

The present disclosure addresses the aforementioned problems and other technological challenges related to throughput performance of programs that benefit from storing frequently accessed datasets in a cache (e.g., such as programs using vector datasets) by providing systems and methods to allocate a first portion of the processor cache to one or more critical tasks (e.g., a first task) of one or more programs. As used herein, a program may be a structure group of one or more tasks that are designed to achieve a particular outcome. In some embodiments, a task may be “critical” if it has a direct and significant impact on the overall performance or execution time of the program. In at least one embodiment, a “critical” task may involve the use of frequently-accessed data. In various embodiments, a task may be considered “critical” based on response latency as a performance metric. A response latency performance metric may refer to how quickly a task should be performed in order to avoid latent or slow interactivity as perceived by a user. In other words, the response latency performance metric may quantify a time delay between a user’s action and a corresponding response. So, in at least some cases, “critical” tasks may be tasks related to a user experience. The processor may have multiple processor cores. Aspects and embodiments of the present disclosure may reserve access control (e.g., at least one specific type of access control such as write operation privileges) to the first portion of the processor cache for a subset of the processor cores. Then, by restricting this subset of processor cores to only perform critical tasks, only data pertaining to the critical tasks may be stored within the first portion of the processor cache since operations (e.g., write operations) to the first portion of the processor cache are restricted to the subset of processor cores. In turn, this reduces cache misses and improves overall latency and performance characteristics of the program.

According to embodiments, to allocate the first portion of the processor cache to the one or more critical tasks, the first portion of the processor cache is assigned to a first class of service (CoS). A subset of processor cores may also be assigned to this first CoS. This subset of processor cores may include at least a first processor core. Then, the first processor core may be assigned critical task(s) to perform.

In some embodiments, the first processor core is restricted from performing non-critical tasks (e.g., additional tasks) once assigned to the first CoS. A “non-critical” task may typically have a lesser or nonsignificant impact on performance or execution time of the program when compared to a critical task. Restricting the first processor core from performing non-critical tasks may be help prevent detrimental cache contention (e.g., data related to these non-critical tasks from overwriting data related to critical tasks). In at least one of these embodiments, a second portion of the processor cache and a second subset of processor cores may be assigned to a second CoS and handle these non-critical tasks.

Aspects and embodiments of the present disclosure may provide that the processor cache is partitioned into cache blocks based on one or more characteristics of the processor cache, including but not limited to a granularity of resource management of the processor cache, a memory size of the processor cache, a cache line size of the processor cache, an associativity metric of the processor cache, and/or a number of cache sets within the processor cache. In some embodiments, a number of cache blocks included in the first portion of the processor cache allocated for critical task(s) may be determined based on an amount of data corresponding to the critical task(s).

According to embodiments, the program may be a generative artificial intelligence (AI) model that implements RAG. Here, critical task(s) may include at least a vector dataset retrieval task of the generative AI model. This vector dataset retrieval task may focus on finding vector(s) of a vector dataset that are most similar to a received query vector. Some or all of this vector dataset may be stored within the first portion of the processor cache. In scenarios where the first portion of the processor cache can concurrently accommodate the entirety of the vector dataset, the entire vector dataset may be loaded into the first portion of the processor cache. In at least one embodiment, once the entire vector dataset (or, more broadly, all data corresponding to the critical task(s)) has been loaded into the first portion of the processor cache, the first portion of the processor cache may be locked so as to prevent evictions from the cache.

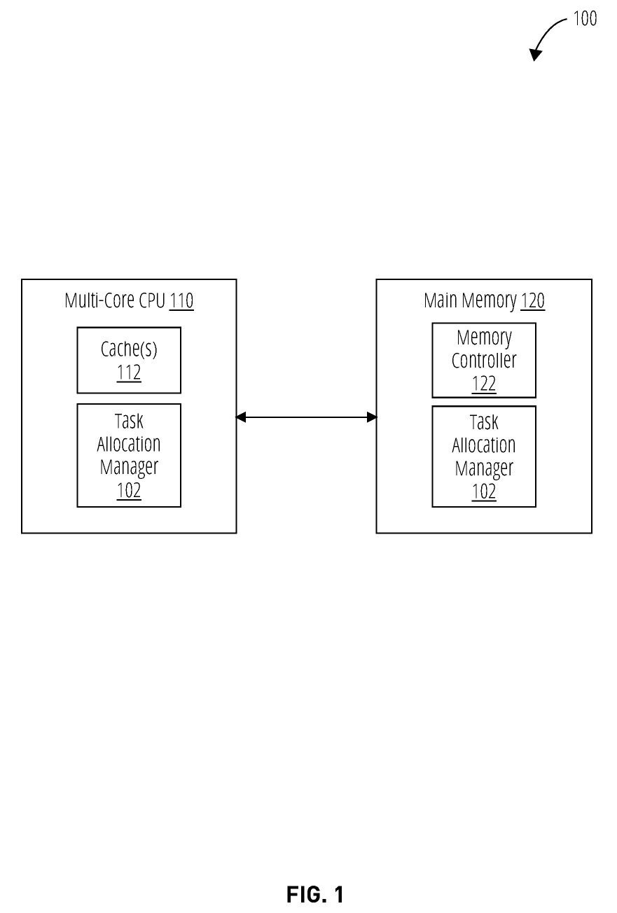

FIG. 1 illustrates a computer system 100, according to one embodiment. The computer system 100 may include a multi-core central processing unit (CPU) 110 operatively coupled to main memory 120. The multi-core CPU 110 may include one or more processor caches 112 that are each operatively coupled to at least one processor core of the multi-core CPU 110. In some embodiments, at least one processor cache 112 is shared between multiple processor cores of the multi-core CPU 110. For example, the processor caches 112 can include a Level 2 ("L2") cache or a Level 3 ("L3") cache shared between some or all of the processor cores of the multi-core CPU 110. In some embodiments, at least some of processor cores of the multi-core CPU 110 may have respective private processor caches 112 (e.g., Level 1 ("L1") caches, L2 caches). In some embodiments, these processor caches 112 may be internal to the multi-core CPU 110 (e.g., located on-chip). In other embodiments, some or all of these processor caches 112 may be external to the multi-core CPU 110 (e.g., located off-chip).

L1, L2, and L3 caches generally differ primarily in terms of memory size, read latency, and cache contention. In general, the L1 cache has the least memory space of these cache types but typically exhibits the lowest respective read latency. L1 caches are typically private to a particular processor core because, in general, L1 caches are located on processor core chips. However, systems and methods of the present disclosure may apply to an L1 cache if it is shared by at least two processor cores. L2 caches have more memory space than L1 caches but have a slightly higher read latency than L1 caches. L2 caches may be shared between multiple processor cores. L3 caches, typically shared among processor cores, contain the largest memory space of these cache types but also has a highest respective read latency. However, compared to main memory, such as dynamic random-access memory (DRAM), L3 caches still exhibit a significantly lower read latency. Thus, while main memory serves as the primary storage for active processes and data, processor caches 112 can provide faster access to frequently used data, reducing the need to access slower main memory. Unless stated otherwise, “shared processor cache,” as used in the present disclosure, refers to a processor cache that is shared by at least two processor cores of a multi-core CPU, such as the multi-core CPU 110.

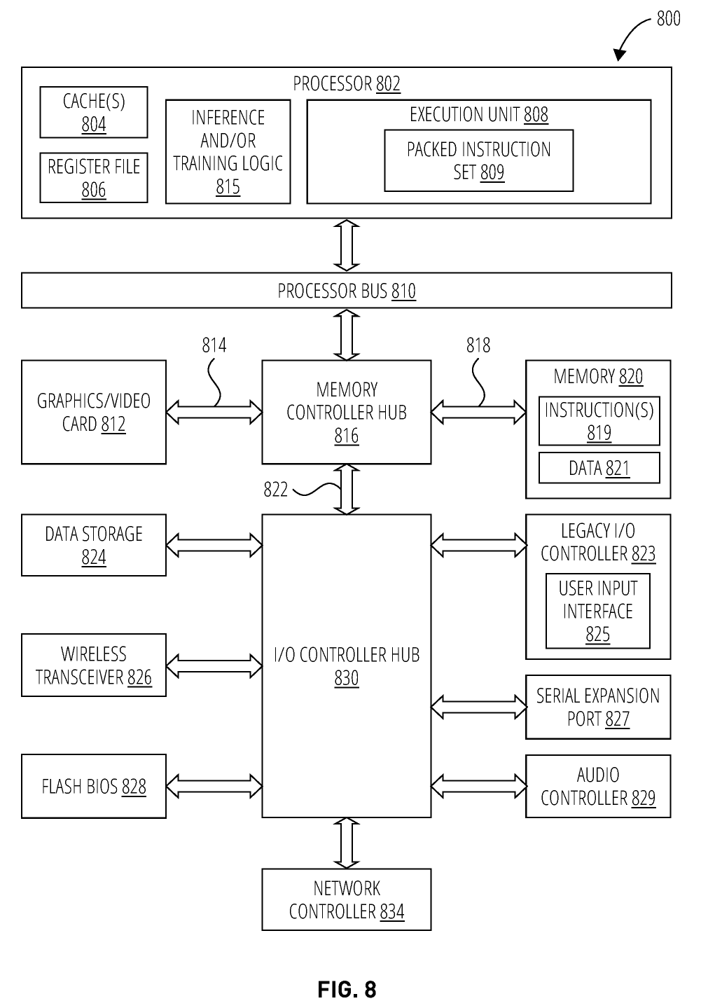

The main memory 120 may include a memory controller 122. The memory controller 122 may include one or more features of the memory controller hub 816 described below with respect to FIG. 8. The memory controller 122 may be responsible for managing and coordinating the flow of data between the multi-core CPU 110 and the main memory 120. The main memory 120 may handle read and write requests from the multi-core CPU 110, translate these requests into specific memory addresses, and facilitate the storing or retrieving of data from memory (e.g., DRAM) based on these requests. The memory controller 122 of main memory 120 may also manage timing and synchronization of memory operations, optimize memory access patterns to improve performance, and/or handle error detection and correction to maintain data integrity. While herein described as a multi-core CPU, in some embodiments, the multi-core CPU may be a different type of multi-core processing unit, such as a data processing unit (DPU), a graphic processing unit (GPU), or any other suitable multi-core processing unit.

The computer system 100 may include a task allocation manager 102. Processor-executable instructions for the task allocation manager 102 may be stored anywhere suitable within the computer system 100, including the main memory 120 or instruction cache(s). Processor core(s) or other processing portions of the multi-core CPU 110 may perform the operations of task allocation manager 102 as described within based on these processor-executable instructions. In at least one embodiment, the task allocation manager 102 may perform operations that cause a first portion of a shared processor cache 112 (i.e., any processor cache 112 that is shared by at least two processor cores of the multi-core CPU 110) to be exclusively reserved for one or more critical tasks. In some embodiments, a critical task may be a task that has a direct and significant impact on the overall performance or execution time of a program that involves frequent reading of same dataset(s). These dataset(s) may be stored in main memory 120. The program may be any one of various programs, including but not limited to operating system applications, model inference applications, model training and updating applications, generative model applications (e.g., generative AI models that may optionally apply Retrieval-Augmented Generation (RAG)), machine learning models, industrial control applications, telecommunication applications, gaming applications, data compression, photo filters, text processing application, object detection (e.g., in images), object removal (e.g., in images), or any other application or program that can be affected by longer runtimes. To exclusively reserve the first portion of the shared processor cache 112, the task allocation manager 102 may reserve or otherwise grant access rights (e.g., writing access) to the first portion of the shared processor cache 112 for a first subset of processor cores with access to the shared processor cache 112. In some embodiments, to reserve this writing access, the first portion of the processor cache 112 and the subset of the processor cores of the multi-core CPU 110 may each be assigned to a first class of service (CoS). By assigning the first portion of the shared processor cache 112 to the first CoS, processor cores not assigned to the first CoS (e.g., a second subset of processor cores assigned to the second CoS that is different from the first subset of processor cores) may be prevented or otherwise restricted from writing to the first portion of the shared processor cache 112. In at least one embodiment, a processor core of the multi-core CPU 110 that has been assigned to a same CoS as the first portion of the shared processor cache 112 (e.g., the first CoS) may not also be assigned to a different CoS (e.g., the second CoS).

In at least one embodiment, classes of service (CoSs) may be used to categorize and/or prioritize resource allocation for computational workloads or processes within a computing system, such as the computer system 100. In the context of the present disclosure, CoSs can be used to manage how resources of the shared processor cache 112 are distributed among different processor cores of the multi-core CPU 110. For example, assigning different portions of a shared processor cache 112, such as an L2 or L3 cache, to different CoSs involves partitioning the shared processor cache 112 so that specific cores have dedicated portions of the shared processor cache 112. Assigning different portions of the shared processor cache 112 to different processor cores helps to reduce cache contention and helps ensure that certain cores, such as the first subset of processor cores as described above, have sufficient cache resources to perform effectively. In at least one embodiment, portions of the shared processor cache 112 may be dynamically allocated to different CoSs based on changing workloads and operating programs. Hardware mechanisms and software policies may work together to manage these allocations. In at least one embodiment, cores not assigned to a certain portion of shared processor cache may still have certain permissions, such as read permissions, to that certain portion of the shared processor cache.

In some embodiments, before the task allocation manager 102 assigns the first portion of the shared processor cache 112 to the first CoS, the task allocation manager 102 (or other configuration manager) may partition the shared processor cache 112 into segmented cache blocks. One or more of these cache blocks may be assigned to a CoS. In other words, the task allocation manager 102 can partition the shared processor cache 112 into segmented cache blocks and then assign cache blocks to one of multiple CoSs to effectively allocate portions (i.e., one or more cache blocks) to assigned CoSs. For example, the first portion of the shared processor cache 112 may include a first number of cache blocks assigned to the first CoS, and a second portion of the shared processor cache 112 may include a second number of cache blocks assigned to the second CoS. In this example, the first and second portions of the shared processor cache 112 may not share a same cache block (e.g., the first and second portions of the shared processor cache 112 may be mutually exclusive). This partitioning of the shared processor cache 112 can be static, where cache blocks are predetermined, or dynamic, where segments are allocated and adjusted in real-time based on one or more characteristics of the shared processor cache 112, program workloads, or other workloads of the computer system 100. The shared processor cache 112 can be partitioned into segmented cache blocks based on various characteristics, such as a minimum granularity of resource management of the shared processor cache 112, a memory size of the shared processor cache 112, a cache line size of the shared processor cache 112, an associativity metric of the shared processor cache 112, a number of cache sets within the shared processor cache 112, usage patterns of the shared processor cache 112, or other performance requirements or metrics of the shared processor cache 112, multi-core CPU 110, or overall computer system 100. For example, frequently accessed data or critical tasks can be allocated a larger portion of the shared processor cache 112 (e.g., a larger number of segmented cache blocks, or larger cache block(s)) to minimize latency and improve performance. Conversely, less critical (non-critical) or infrequently accessed data can be assigned a smaller portion of the shared processor cache 112. This segmentation can be managed through hardware mechanisms, which directly control cache access and allocation, software policies that dynamically adjust partitioning based on real-time analysis of cache usage, or a combination thereof.

The task allocation manager 102 may also restrict the first subset of processor cores from performing any task that is not a critical task of the program. In other words, the task allocation manager 102 may restrict the first subset of processor cores from performing additional tasks that are not critical tasks of the program. These additional tasks may be non-critical tasks. Non-critical tasks of a program may include, but are not limited to, logging user query history, performing routine data integrity checks, updating a database with non-urgent entries, running background analytics for user interaction patterns, remote administrative access (both interactive and non-interactive, e.g., user- or computer-driven), log maintenance, or the like. Non-critical tasks can also include non-urgent tasks, such as background data synchronization, routine file indexing, scheduled system backups, periodic software updates, non-urgent data compression, or non-urgent encryption tasks. Conversely, critical tasks may include, but are not limited to, one or more of real-time data processing tasks, operating system (OS) tasks, database management tasks, network management tasks, user interface responsiveness tasks, industrial control application tasks, telecommunication application tasks, gaming application tasks, data compression tasks, photo filtering tasks, text processing application tasks, object detection tasks (e.g., in images), object removal tasks (e.g., in images), or the like. In embodiments where the program is an artificial intelligence (AI) model application, critical tasks may include, but are not limited to, one or more of inference processing tasks, model training or model update tasks, data preprocessing tasks, error detection tasks, or the like. In embodiments where the program is a generative AI model (e.g., which may apply Retrieval-Augmented Generation (RAG)), critical tasks may include, but are not limited to, one or more of a real-time query processing task, an information retrieval task such as a vector dataset retrieval task (also referred to as an embedding retrieval), a text generation task, a relevance scoring task, a model inference task, or an error handling and recovery task.

In some embodiments, a second subset (e.g., additional processor cores) of processor cores of the multi-core CPU 110 may be configured to perform the additional tasks that the first subset of processors is restricted from performing. These first and second subsets of processors may be mutually exclusive. In other words, in some embodiments, the first and second subsets of processor cores may not share a same processor core. These processor cores of the second subset may not be assigned to a same CoS as the first portion of the shared processor cache 112. As such, because the second subset of processor cores performs the additional tasks described above, these additional tasks may not write data to the first portion of the shared processor cache 112. The second subset of processor cores may be assigned to one or more different CoSs than the first CoS (e.g., the second CoS, a third CoS). Similarly, a second portion of the shared processor cache 112 may also be assigned one or more of these different CoSs than the first CoS.

In at least one embodiment, the additional tasks may also include critical tasks of different programs. However, to avoid cache contention and reserve the first portion of the processor cache 112 for critical task(s) of the program, the first subset of processor cores may be restricted from performing all other additional queued tasks besides the critical task(s) for the program, whether they be critical or non-critical. Critical task(s) of other programs may be assigned to other cores of the CPU or rescheduled.

According to embodiments, the task allocation manager 102 may prioritize certain critical tasks over others. For example, in one embodiment, the computer system 100 may handle multiple interactive tasks that may not have a defined stop point (e.g., serving a webpage that allows users to interact with the model through a web browser). Here, while the task of serving the webpage and the task of performing model inference are both critical to the user experience, the task allocation manager 102 may prioritize the model inference over serving the webpage, even though the model may not be used without the website.

In some embodiments, the task allocation manager 102 may designate one or more task(s) of the program as critical based on a variety of factors, including but not limited to how often the task accesses a same dataset, time sensitivity, bottleneck avoidance, or user impact. In at least one embodiment, tasks of programs may already be tagged or otherwise marked as critical or non-critical (e.g., via a launch script where task priorities are pre-assigned). A program may also self-assign priority to its tasks via an adaptive functionality embedded within the program that communicates the priority assignment to the operating system (OS) apriori at the time of writing the program in such a way that the functionality is enabled during program runtime upon detecting that the OS supports the self-assignment. In at least one embodiment, priorities of tasks may be adaptively assigned based on the above factors (or others). According to embodiments, critical task(s) of the program may be tagged or otherwise assigned to a same CoS as the first portion of the shared processor cache 112 (e.g., the first CoS), while non-critical task(s) may be tagged or otherwise assigned to a different CoS as the first portion of the shared processor cache 112 (e.g., the second CoS). According to some embodiments, a size (e.g., an amount of memory space) of the first portion of the shared processor cache 112 may be based on a size of dataset(s) corresponding to these critical task(s). For example, if these corresponding dataset(s) are 72 kilobytes (KB), and the shared processor cache 112 has at least 72 KB of memory space, the first portion of the processor cache 112 may be at least 72 KB. In other embodiments, the first portion of the shared processor cache 112 may be predefined without consideration of the size of data corresponding to the critical task(s) of the program. In some embodiments, the task allocation manager 102 may ensure that at least some memory space of the shared processor cache 112 is reserved for non-critical tasks.

As described above, frequently-accessed dataset(s) may correspond to the critical task(s) of the program. These dataset(s) may be loaded and stored into the first portion of the shared processor cache 112 by processor cores of the first subset. Because other processor cores (e.g., processor cores of a second subset) are not assigned to a same CoS as the first portion of the shared processor cache 112 (e.g., assigned to a second CoS instead of the first CoS), these dataset(s) may not be evicted from the shared processor cache 112 by other data corresponding to non-critical tasks. In at least some embodiments, this dataset may be a vector dataset. Many different types of programs use vector datasets, such as machine learning models (MLMs) or other types of AI models, natural language processing (NLP) applications, user recommendation applications, image processing or computer vision applications, search engine applications, control system applications, data visualization applications, or the like. One such example of a program that uses a vector dataset is the generative AI model application that employs RAG. The generative AI model application can use a vector dataset to enhance the relevance of its responses by converting both the user query and the documents in its database into high-dimensional vectors. These vectors can capture the semantic meaning of the text. The generative AI model then calculates similarity scores between the query vector and the document vectors using methods including but not limited to cosine similarity or Euclidean distance. To calculate these similarity scores, the generative AI model accesses the vector database at least once (in some RAG applications, more than once) for each received user query. By ranking the documents based on these similarity scores, the generative AI model identifies the most relevant documents to retrieve. These top-ranked documents are then used to augment the generation process, which can facilitate more accurate and contextually appropriate responses to the user query.

In at least some cases, the first portion of the shared processor cache 112 may have a sufficient memory space large enough to concurrently store the entire amount of data of the dataset(s) corresponding to these critical task(s). In these embodiments, the dataset(s) may be loaded into the first portion of the shared processor cache 112, which may be locked thereafter to prevent evictions from the cache to the main memory 120. Here, the first portion of the shared processor cache 112 may be locked until the critical task(s) are no longer performed by the multi-core CPU 110 or program operation otherwise ceases. Thus, the first portion of the shared processor cache 112 may be locked for several iterations of the program. For example, if the program is a generative AI model application that uses RAG, the first portion of the shared processor cache 112 may be locked for several consecutive retrieval-generation cycles of the RAG implementation.

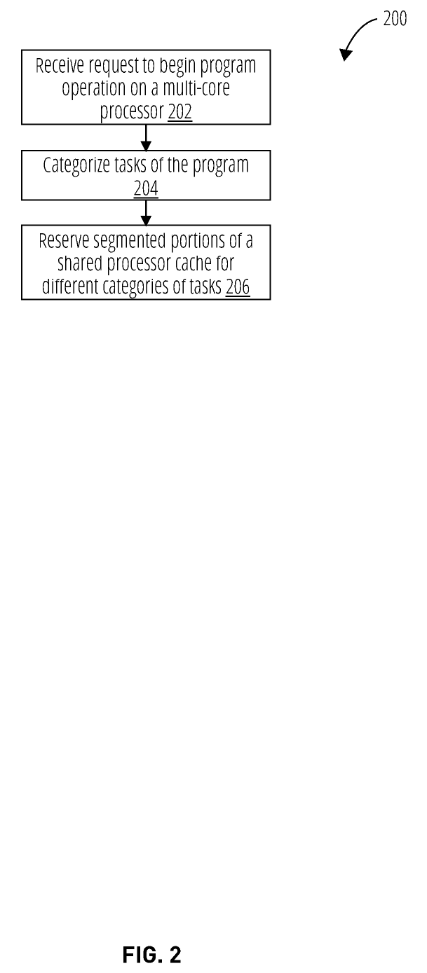

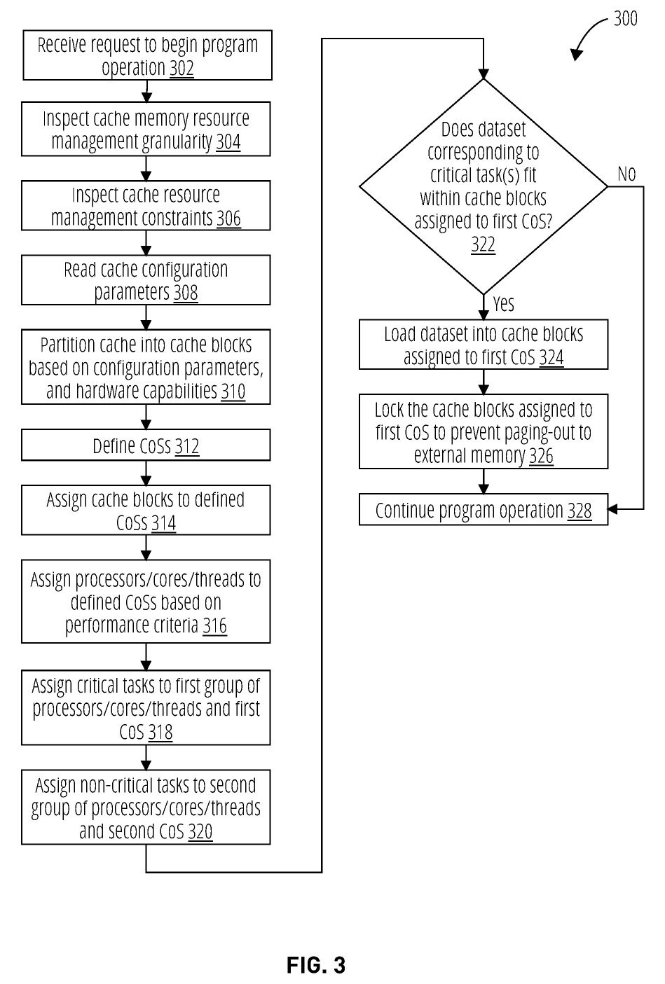

FIG. 2 is a flowchart illustrating an example method 200 of exclusively reserving of a portion of a shared processor cache for one or more tasks, according to one embodiment. FIG. 3 is a flowchart illustrating an example method 300 of exclusively reserving a portion of a shared processor cache for critical tasks, according to one embodiment. Methods 200, 300 may be related to operations of the task allocation manager 102 as described herein.

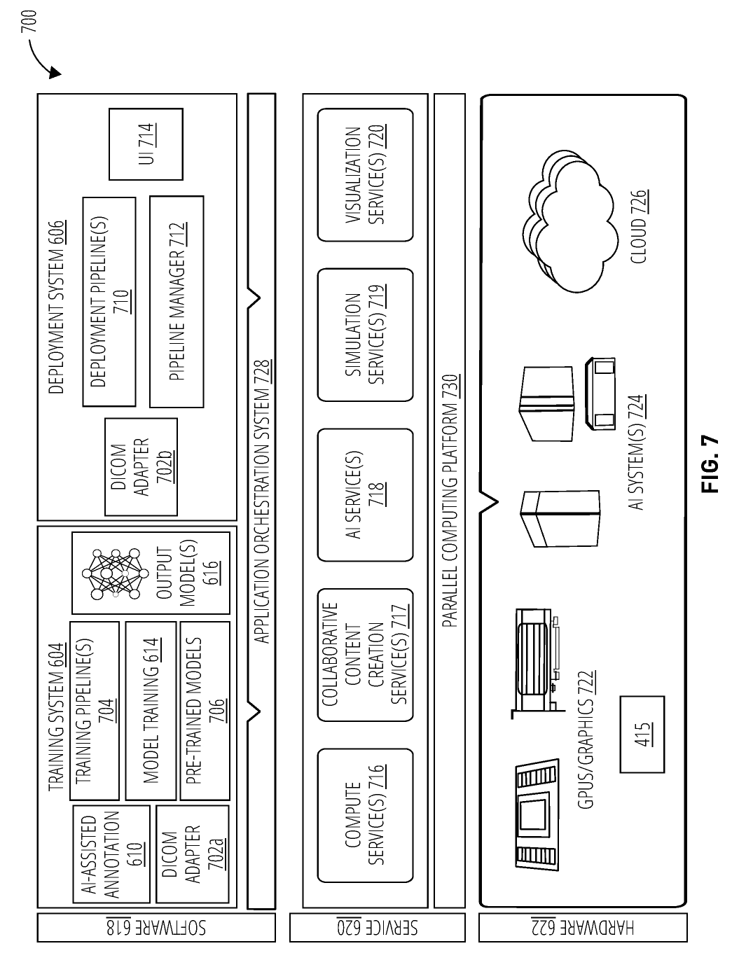

Methods 200 and/or 300 can be performed using processing unit(s) with multiple processor cores, such as the multi-core CPU 110 as described above with respect to FIG. 1, which may include (or communicate with) one or more memory devices. In at least one embodiment, methods 200 and/or 300 can be performed using a processing device or processing devices that share a processor cache or another type of similar memory structure. In at least one embodiment, methods 200 and/or 300 can be performed using the multi-core CPU 110 of FIG. 1. In at least one embodiment, methods 200 and/or 300 can be performed by computer systems 700, 800 of FIG. 7 and FIG. 8, respectively. In at least one embodiment, a processing unit performing any of methods 200 and/or 300 can be executing instructions stored on a non-transient computer readable storage media. In other words, memory storing instructions that, when executed by a processing unit, can perform any of the methods 200 and/or 300. In at least one embodiment, any of methods 200 and/or 300 can be performed using multiple processing threads (e.g., CPU threads), individual threads executing one or more individual functions, routines, subroutines, or operations of the method. In at least one embodiment, processing threads implementing any of methods 200 and/or 300 can be synchronized (e.g., using semaphores, critical sections, and/or other thread synchronization mechanisms). Alternatively, processing threads implementing any of methods 200 and/or 300 can be executed asynchronously with respect to each other. Various operations of methods 200 and/or 300 can be performed in a different order compared with the order shown in FIG. 2 and/or FIG. 3. Some operations of any of methods 200 and/or 300 can be performed concurrently with other operations. In at least one embodiment, one or more operations shown in FIG. 2 and/or FIG. 3 may not always be performed.

FIG. 2 is a flowchart illustrating an example method 200 of exclusively reserving of a portion of a shared processor cache for one or more tasks, according to one embodiment.

At block 202, processing unit(s) executing method 200 can receive a request to begin program operation on a multi-core processor. Multiple iterations of the program may be performed before program operation ceases. In at least one embodiment, program operation may include several iterations of these tasks before program operation ceases.

At block 204, processing unit(s) executing method 200 can categorize tasks of the program into different categories or types based on one or more characteristics of each task. One example of such a categorization is the interactive tasks of serving a webpage with an interactive model, described above with respect to FIG. 1. In one embodiment, a first task that often accesses a same dataset may be categorized as a “critical” task (e.g., first type), while a second task that does not often access a same dataset may be categorized as a “non-critical” task (e.g., second type). In another embodiment, a first task that has a significant impact on program iteration runtime may be categorized as a “critical” task, while a second task that has a lesser or insignificant impact on program iteration runtime may be categorized as a “non-critical” task. In some embodiments, the multi-core processor may concurrently perform tasks for different programs. Here, a first task corresponding to a first program may be categorized as a “first program” task (e.g., first type), and a second task corresponding to a second program may be categorized as a “second program” task (e.g., second type). Further, task(s) of the first and second programs that often access a same dataset may also be categorized as “critical” task(s), while task(s) of the first and second programs that do not often access a same dataset may also be categorized as “non-critical” task(s) (e.g., third type). In addition to the above, tasks of the program may also be categorized based on priority levels (e.g., quality of service (QoS), prioritizing critical or time-sensitive tasks), temporal relevance (e.g., real-time tasks compared to non-real-time tasks), user impact, or the like. According to embodiments, an out-of-band or apriori declaration of the importance of tasks of a program may be made by a developer, user, or the program itself. Tasks may be assigned priority based on their relative importance based on this declaration.

At block 206, processing unit(s) executing method 200 can reserve segmented portions of a shared processor cache for different categories of tasks. The processing unit(s) may reserve these segmented portions of the shared processor cache in a same or similar manner as what is described above with respect to FIG. 1. For example, segmented portions of the shared processor and mutually exclusive subsets of processor cores may be assigned respective CoSs, which respective CoSs may also be assigned to categorized tasks. In one embodiment, at least two segmented portions of the shared processor cache may be reserved for mutually exclusive categories of categorized tasks, such as “critical” and “non-critical” tasks. In another embodiment, more than two segmented portions of the shared processor cache may be reserved for different categories of tasks. For example, a first segmented portion may be reserved for “first program” “critical” tasks, a second portion may be reserved for “second program” “critical” tasks, and a third portion may be reserved for “non-critical” tasks. In at least one embodiment, this third portion may be reserved for “non-critical” tasks irrespective of whether these tasks are additionally categorized as “first program” or “second program” tasks. In one embodiment, the processing unit(s) may assign each segmented portion of the shared processor cache.

In some embodiments, the shared processor cache may be segmented into portions based on currently queued tasks of program(s) operating on the multi-core processor. In another embodiment, the shared processor cache may be segmented into reserved portions based on type(s) of program(s) operating on the multi-core processor. In this embodiment, the shared processor cache may be segmented into reserve portions before any task for an operating program is received. In another embodiment, the shared processor cache may be segmented into reserved portions before operations of program(s) begin. Here, the processor cache may be segmented into reserved portions based on historical uses of the multi-core processor, historical program operations of the multi-core processor, or predetermined configuration settings (e.g., if the multi-core processor is dedicated to a particular program).

FIG. 3 is a flowchart illustrating an example method 300 of reserving a portion of a shared processor cache for critical tasks, according to one embodiment. In at least one embodiment, this reservation may be exclusive (i.e., tasks other than these critical tasks are not permitted to use the reserved portion of the processor cache). In some embodiments, one or more operations of the method 300 are configuration operations designed to configure a computing system (e.g., the computer system 100) before the computing system performs one or more operations corresponding to a program. The method 300 may be performed by one or more processing unit(s), which may also be referred to as processing circuitry.

At block 302, processing unit(s) executing method 300 can receive a request to begin program operation. This request may be any type of command, trigger, script, user input, or any other indication that program operation is to begin. In at least one embodiment, this program may be a generative AI model that optionally uses RAG.

At block 304, processing unit(s) executing method 300 can inspect a memory resource management granularity of the shared processor cache. This memory resource management granularity may refer to the smallest unit of memory that can be managed within the shared processor cache. So, the memory resource management granularity can directly affect how large or small cache blocks of the shared processor cache can be segmented or partitioned. The processing unit(s) may use the memory resource management granularity as a factor in determining a size of the shared processor cache portion reserved for critical tasks (e.g., the first portion of the shared processor cache).

At block 306, processing unit(s) executing method 300 can inspect resource management constraints of the shared processor cache. Here, the processing unit(s) may determine how the cache can be partitioned and assigned. For example, in some cases, partitioned cache blocks can only be assigned in a contiguous manner. As another example, the shared processor cache may have either overlapping or non-overlapping CoS blocks.

At block 308, processing unit(s) executing method 300 can read configuration parameters of the shared processor cache. These configuration parameters of the shared processor cache may be indicative of one or more of a size of the shared processor cache (e.g., memory space), a cache line size, associativity, write policy (write-through or write-back), cache latency, inclusion policy (inclusive, exclusive, or non-inclusive), coherence protocol, or prefetching strategy. The configuration parameters can include task priority assignment/declaration, processor core assignment to CoS, and cache split description to CoS. In one embodiment, the configuration parameters may be read by the processing unit(s) via a launcher script/program that communicates with the OS and places the task in the appropriate CoS. In another embodiment, the processing unit(s) read the configuration parameters via the target application and assigns the target application to the appropriate class based on the configuration parameters.

At block 310, processing unit(s) executing method 300 can partition the shared processor cache into cache blocks. In some embodiments, this partition may be based on the configuration parameters and/or known hardware capabilities (or limitations) of the shared processor cache. In at least one embodiment, this partition can be at least partially based on the memory resource management granularity determined at block 304. In at least one embodiment, operations of blocks 304, 306, 308, 310 may occur before the request to begin program operation is received at block 302. In another embodiment, the operations of blocks 304, 306, 308, 310 may be dependent on receiving the request to begin program operation at block 302.

At block 312, processing unit(s) executing method 300 can define classes of service (CoS). These CoSs may each be associated with one or more of a performance requirement, a priority level, or a quality of service (QoS) metric. At least a first CoS and a second CoS may be defined. In some embodiments, the first CoS may correspond to critical tasks as described herein and the second CoS may correspond to non-critical tasks as described herein.

At block 314, processing unit(s) executing method 300 can assign one or more segmented cache block(s) of the shared processor cache to a class of service. In some embodiments, cache block(s) assigned to the first CoS are not also assigned to a different CoS. In at least one embodiment, cache block(s) assigned to the first CoS may be referred to as the portion of the shared processor cache allocated or otherwise reserved for critical tasks.

At block 316, processing unit(s) executing method 300 can assign processor cores and/or processor threads to these classes of service. This may involve mapping each processor core or thread to at least one of the defined CoSs. A first subset of processor cores may be assigned to the first CoS, while a second subset of processor cores may be assigned to the second CoS. In at least one embodiment, the first and second subsets of processor cores may not share a same processor core (i.e., the first and second subsets of processor cores may be mutually exclusive). In at least one embodiment, operations of blocks 312, 314, 316 may occur before the request to begin program operation is received at block 302. In another embodiment, the operations of blocks 312, 314, 316 may be dependent on receiving the request to begin program operation at block 302.

At block 318, processing unit(s) executing method 300 can assign critical tasks of the program to the first subset of processor cores and/or processor threads assigned to a first CoS. In at least one embodiment, the critical tasks may also be assigned to the first CoS. Here, processing unit(s) executing method 300 can determine which tasks of the program are critical, and then assign these critical tasks accordingly. Criticality of any particular task may be determine as described herein. In embodiments where the program is a generative AI model that applies RAG, critical tasks may include, but are not limited to, one or more of a retrieval task (e.g., searching through large dataset (vectors or documents) to find vectors/documents relevant to user query) or a generation task (e.g., generating a contextually appropriate response to user query based on relevant vectors/documents identified in the retrieval step).

At block 320, processing unit(s) executing method 300 can assign non-critical tasks of the program to a second subset of processor cores and/or processor threads assigned to a second CoS. In at least one embodiment, the non-critical tasks may also be assigned to the second CoS. Here, processing unit(s) executing method 300 can determine which tasks of the program are non-critical, and then assign these non-critical tasks accordingly. Criticality of any particular task may be determine as described herein. In embodiments where the program is a generative AI model application, non-critical tasks may include, but are not limited to, one or more of preprocessing tasks, postprocessing tasks, and/or lightweight inference tasks.

At decision block 322, processing unit(s) executing method 300 can determine whether dataset(s) corresponding to the critical task(s) of the program fit within the first portion of the shared processor cache. For example, processing unit(s) executing method 300 can determine whether the first portion of the shared processor cache has sufficient memory space large enough to concurrently store the entire amount of data of the dataset(s) corresponding to the critical task(s) of the program. If the first portion of the shared processor cache has enough memory space to concurrently store the entire amount of data of these dataset(s), the method 300 may continue at block 324. If not, the method 300 may continue at block 328.

At block 324, processing unit(s) executing method 300 can load the dataset(s) corresponding to the critical task(s) of the program into the first portion of the shared processor cache. These dataset(s) may be stored on external memory, such as main memory 120 of FIG. 1.

At block 326, once the dataset(s) have been loaded onto the first portion of the shared processor cache, processing unit(s) executing method 300 can lock the first portion of the shared processor cache so as to prevent evictions from the cache to main memory or otherwise cause cache eviction of data loaded onto the first portion of the shared processor cache. The first portion of the shared processor cache may be locked as described using any suitable system or process. In at least one embodiment, the first portion of the shared processor cache may be locked by marking cache lines of the first portion as non-evictable.

At block 328, processing unit(s) executing method 300 can continue program operation. In embodiments where the program is a RAG model application, this continued program operation may include waiting for a user query or performing a retrieval task, as described herein.

### INFERENCE AND TRAINING LOGIC

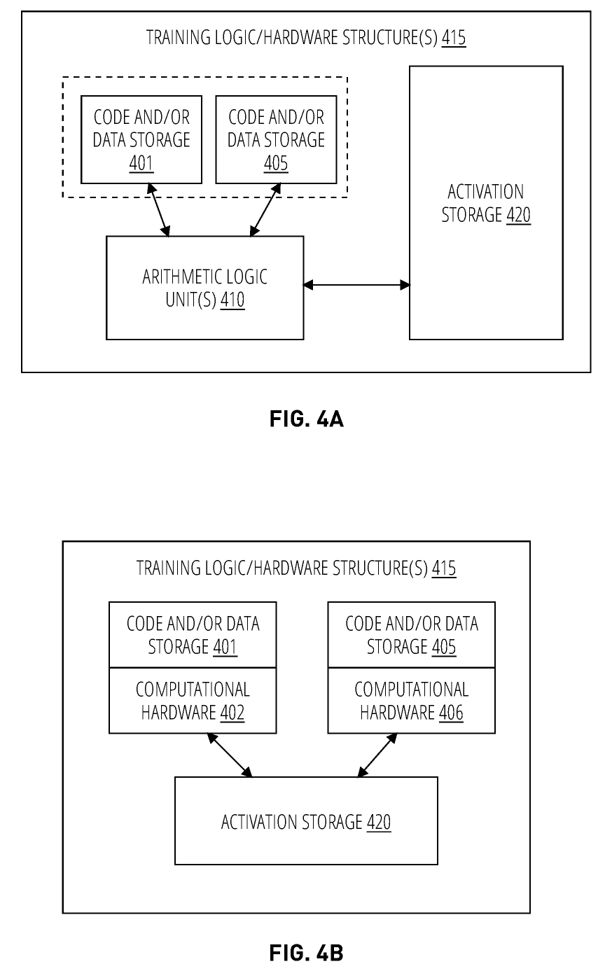

FIG. 4A illustrates inference and/or training logic 415 used to perform inferencing and/or training operations associated with one or more embodiments.

In at least one embodiment, inference and/or training logic 415 may include, without limitation, code and/or data storage 401 to store forward and/or output weight and/or input/output data, and/or other parameters to configure neurons or layers of a neural network trained and/or used for inferencing in aspects of one or more embodiments. In at least one embodiment, training logic 415 may include (or be coupled to code and/or data storage 401 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 401 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 401 may be included with other on-chip or off-chip data storage, including a processor’s L1, L2, or L3 cache or system memory.

In at least one embodiment, any portion of code and/or data storage 401 may be internal or external to one or more processors or other hardware logic devices or circuits. In at least one embodiment, code and/or data storage 401 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 401 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 415 may include, without limitation, a code and/or data storage 405 to store backward and/or output weight and/or input/output data corresponding to neurons or layers of a neural network trained and/or used for inferencing in aspects of one or more embodiments. In at least one embodiment, code and/or data storage 405 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 415 may include (or be coupled to code and/or data storage 405 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 405 may be included with other on-chip or off-chip data storage, including a processor’s L1, L2, or L3 cache or system memory. In at least one embodiment, any portion of code and/or data storage 405 may be internal or external to one or more processors or other hardware logic devices or circuits. In at least one embodiment, code and/or data storage 405 may be cache memory, DRAM, SRAM, non-volatile memory (e.g., flash memory), or other storage. In at least one embodiment, a choice of whether code and/or data storage 405 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or code and/or data storage 401 and code and/or data storage 405 may be separate storage structures. In at least one embodiment, code and/or data storage 401 and code and/or data storage 405 may be a combined storage structure. In at least one embodiment, code and/or data storage 401 and code and/or data storage 405 may be partially combined and partially separate. In at least one embodiment, any portion of code and/or data storage 401 and code and/or data storage 405 may be included with other on-chip or off-chip data storage, including a processor’s L1, L2, or L3 cache or system memory.

In at least one embodiment, inference and/or training logic 415 may include, without limitation, one or more arithmetic logic unit(s) (“ALU(s)”) 410, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 420 that are functions of input/output and/or weight parameter data stored in code and/or data storage 401 and/or code and/or data storage 405. In at least one embodiment, activations stored in activation storage 420 are generated according to linear algebraic and/or matrix-based mathematics performed by ALU(s) 410 in response to performing instructions or other code, wherein weight values stored in code and/or data storage 405 and/or code and/or data storage 401 are used as operands along with other values, such as bias values, gradient information, momentum values, or other parameters or hyperparameters, any or all of which may be stored in code and/or data storage 405 or code and/or code and/or data storage 401 or another storage on or off-chip.

In at least one embodiment, ALU(s) 410 are included within one or more processors or other hardware logic devices or circuits, whereas in another embodiment, ALU(s) 410 may be external to a processor or other hardware logic device or circuit that uses them (e.g., a co-processor). In at least one embodiment, ALU(s) 410 may be included within a processor’s execution units or otherwise within a bank of ALUs accessible by a processor’s execution units either within the same processor or distributed between different processors of different types (e.g., central processing units, graphics processing units, fixed function units, etc.). In at least one embodiment, code and/or data storage 401, code and/or data storage 405, and activation storage 420 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 420 may be included with other on-chip or off-chip data storage, including a processor’s L1, L2, or L3 cache or system memory. Furthermore, inferencing and/or training code may be stored with other code accessible to a processor or other hardware logic or circuit and fetched and/or processed using a processor’s fetch, decode, scheduling, execution, retirement and/or other logical circuits.

In at least one embodiment, activation storage 420 may be cache memory, DRAM, SRAM, non-volatile memory (e.g., flash memory), or other storage. In at least one embodiment, activation storage 420 may be completely or partially within or external to one or more processors or other logical circuits. In at least one embodiment, a choice of whether activation storage 420 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 415 illustrated in FIG. 4A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 415 illustrated in FIG. 4A may be used in conjunction with central processing unit (“CPU”) hardware, graphics processing unit (“GPU”) hardware or other hardware, such as field programmable gate arrays (“FPGAs”).

FIG. 4B illustrates inference and/or training logic 415, according to at least one embodiment. In at least one embodiment, inference and/or training logic 415 may include, without limitation, hardware logic in which computational resources are dedicated or otherwise exclusively used in conjunction with weight values or other information corresponding to one or more layers of neurons within a neural network. In at least one embodiment, inference and/or training logic 415 illustrated in FIG. 4B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 415 illustrated in FIG. 4B may be used in conjunction with central processing unit (CPU) hardware, graphics processing unit (GPU) hardware or other hardware, such as field programmable gate arrays (FPGAs). In at least one embodiment, inference and/or training logic 415 includes, without limitation, code and/or data storage 401 and code and/or data storage 405, which may be used to store code (e.g., graph code), weight values and/or other information, including bias values, gradient information, momentum values, and/or other parameter or hyperparameter information. In at least one embodiment illustrated in FIG. 4B, each of code and/or data storage 401 and code and/or data storage 405 is associated with a dedicated computational resource, such as computational hardware 402 and computational hardware 406, respectively. In at least one embodiment, each of computational hardware 402 and computational hardware 406 comprises one or more ALUs that perform mathematical functions, such as linear algebraic functions, only on information stored in code and/or data storage 401 and code and/or data storage 405, respectively, the result of which is stored in activation storage 420.

In at least one embodiment, each of code and/or data storage 401 and 405 and corresponding computational hardware 402 and 406, respectively, correspond to different layers of a neural network, such that resulting activation from one storage/computational pair 401/402 of code and/or data storage 401 and computational hardware 402 is provided as an input to a next storage/computational pair 405/406 of code and/or data storage 405 and computational hardware 406, in order to mirror a conceptual organization of a neural network. In at least one embodiment, each of storage/computational pairs 401/402 and 405/406 may correspond to more than one neural network layer. In at least one embodiment, additional storage/computation pairs (not shown) subsequent to or in parallel with storage/computation pairs 401/402 and 405/406 may be included in inference and/or training logic 415.

### NEURAL NETWORK TRAINING AND DEPLOYMENT

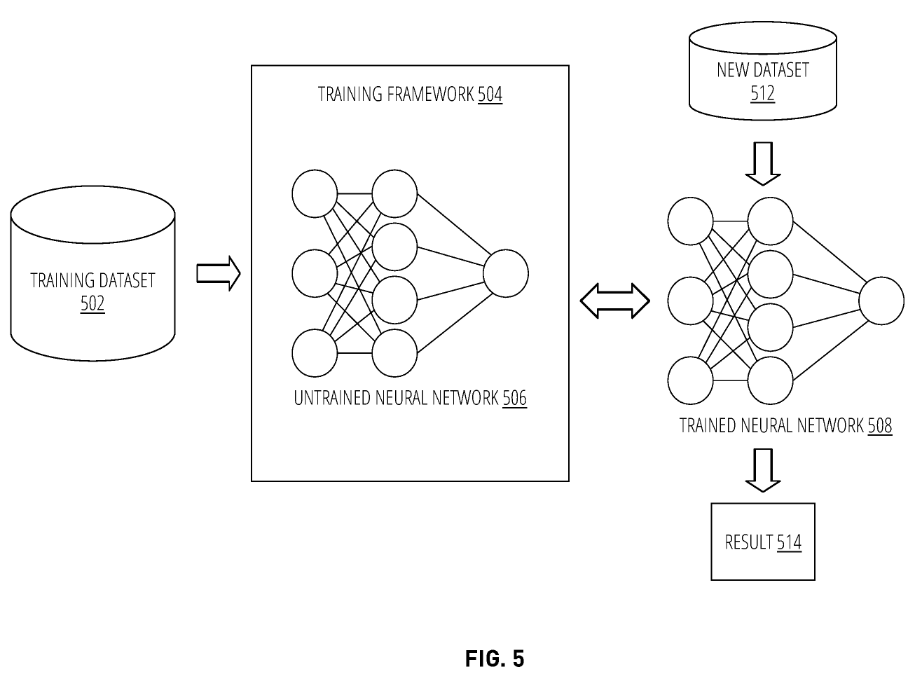

FIG. 5 illustrates training and deployment of a deep neural network, according to at least one embodiment. In at least one embodiment, untrained neural network 506 is trained using a training dataset 502. In at least one embodiment, training framework 504 is a PyTorch framework, whereas in other embodiments, training framework 504 is a TensorFlow, Boost, Caffe, Microsoft Cognitive Toolkit/CNTK, MXNet, Chainer, Keras, Deeplearning4j, or other training framework. In at least one embodiment, training framework 504 trains an untrained neural network 506 and enables it to be trained using processing resources described herein to generate a trained neural network 508. In at least one embodiment, weights may be chosen randomly or by pre-training using a deep belief network and/or a different previously trained model. In at least one embodiment, training may be performed in either a supervised, partially supervised, or unsupervised manner.

In at least one embodiment, untrained neural network 506 is trained using supervised learning, wherein training dataset 502 includes an input paired with a desired output for an input, or where training dataset 502 includes input having a known output and an output of neural network 506 is manually graded. In at least one embodiment, untrained neural network 506 is trained in a supervised manner and processes inputs from training dataset 502 and compares resulting outputs against a set of expected or desired outputs. In at least one embodiment, errors are then propagated back through untrained neural network 506. In at least one embodiment, training framework 504 adjusts weights that control untrained neural network 506. In at least one embodiment, training framework 504 includes tools to monitor how well untrained neural network 506 is converging towards a model, such as trained neural network 508, suitable to generating correct answers, such as in result 514, based on input data such as a new dataset 512. In at least one embodiment, training framework 504 trains untrained neural network 506 repeatedly while adjusting weights to refine an output of untrained neural network 506 using a loss function and adjustment algorithm, such as stochastic gradient descent. In at least one embodiment, training framework 504 trains untrained neural network 506 until untrained neural network 506 achieves a desired accuracy. In at least one embodiment, trained neural network 508 can then be deployed to implement any number of machine learning operations.

In at least one embodiment, untrained neural network 506 is trained using unsupervised learning, wherein untrained neural network 506 attempts to train itself using unlabeled data. In at least one embodiment, unsupervised learning training dataset 502 will include input data without any associated output data or “ground truth” data. In at least one embodiment, untrained neural network 506 can learn groupings within training dataset 502 and can determine how individual inputs are related to untrained dataset 502. In at least one embodiment, unsupervised training can be used to generate a self-organizing map in trained neural network 508 capable of performing operations useful in reducing dimensionality of new dataset 512. In at least one embodiment, unsupervised training can also be used to perform anomaly detection, which allows identification of data points in new dataset 512 that deviate from normal patterns of new dataset 512.

In at least one embodiment, semi-supervised learning may be used, which is a technique in which training dataset 502 includes a mix of labeled and unlabeled data. In at least one embodiment, training framework 504 may be used to perform incremental learning, such as through transferred learning techniques. In at least one embodiment, incremental learning enables trained neural network 508 to adapt to new dataset 512 without forgetting knowledge instilled within trained neural network 508 during initial training.

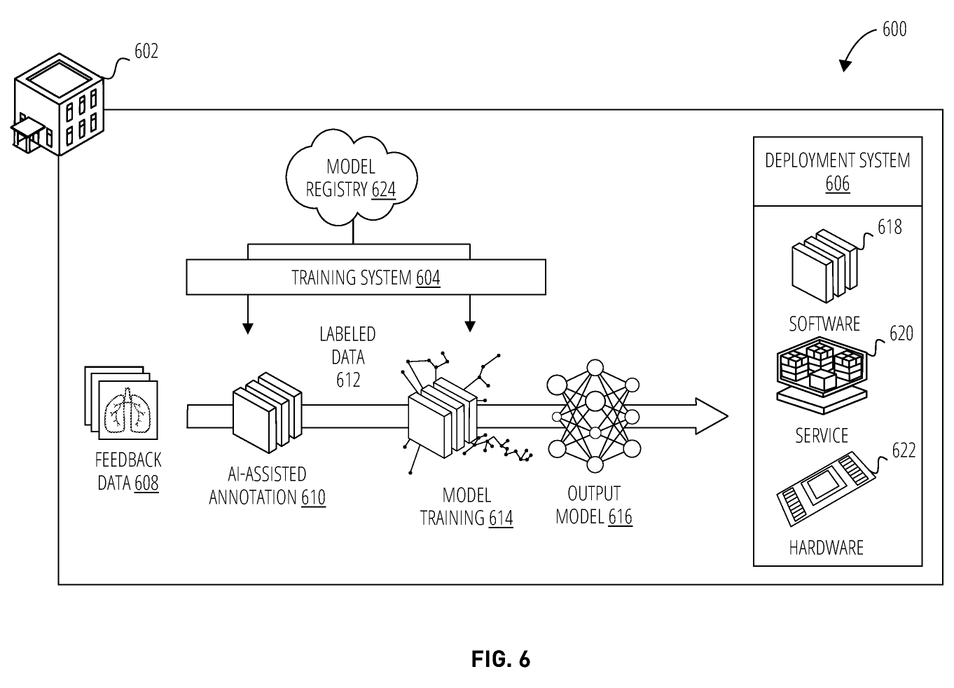

With reference to FIG. 6, FIG. 6 is an example data flow diagram for a process 600 of generating and deploying a processing and inferencing pipeline, according to at least one embodiment. In at least one embodiment, process 600 may be deployed to perform game name recognition analysis and inferencing on user feedback data at one or more facilities 602, such as a data center.

In at least one embodiment, process 600 may be executed within a training system 604 and/or a deployment system 606. In at least one embodiment, training system 604 may be used to perform training, deployment, and embodiment of machine learning models (e.g., neural networks, object detection algorithms, computer vision algorithms, etc.) for use in deployment system 606. In at least one embodiment, deployment system 606 may be configured to offload processing and compute resources among a distributed computing environment to reduce infrastructure requirements at facility 602. In at least one embodiment, deployment system 606 may provide a streamlined platform for selecting, customizing, and implementing virtual instruments for use with computing devices at facility 602. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 606 during execution of applications.

In at least one embodiment, some applications used in advanced processing and inferencing pipelines may use machine learning models or other AI to perform one or more processing steps. In at least one embodiment, machine learning models may be trained at facility 602 using feedback data 608 (such as imaging data) stored at facility 602 or feedback data 608 from another facility or facilities, or a combination thereof. In at least one embodiment, training system 604 may be used to provide applications, services, and/or other resources for generating working, deployable machine learning models for deployment system 606.

In at least one embodiment, a model registry 624 may be backed by object storage that may support versioning and object metadata. In at least one embodiment, object storage may be accessible through, for example, a cloud storage (e.g., a cloud 726 of FIG. 7) compatible application programming interface (API) from within a cloud platform. In at least one embodiment, machine learning models within model registry 624 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 704 (FIG. 7) may include a scenario where facility 602 is training their own machine learning model or has an existing machine learning model that needs to be optimized or updated. In at least one embodiment, feedback data 608 may be received from various channels, such as forums, web forms, or the like. In at least one embodiment, once feedback data 608 is received, AI-assisted annotation 610 may be used to aid in generating annotations corresponding to feedback data 608 to be used as ground truth data for a machine learning model. In at least one embodiment, AI-assisted annotation 610 may include one or more machine learning models (e.g., convolutional neural networks (CNNs)) that may be trained to generate annotations corresponding to certain types of feedback data 608 (e.g., from certain devices) and/or certain types of anomalies in feedback data 608. In at least one embodiment, AI-assisted annotations 610 may then be used directly, or may be adjusted or fine-tuned using an annotation tool, to generate ground truth data. In at least one embodiment, in some examples, labeled data 612 may be used as ground truth data for training a machine learning model. In at least one embodiment, AI-assisted annotations 610, labeled data 612, or a combination thereof may be used as ground truth data for training a machine learning model, e.g., via model training 614 in FIG. 6 and/or FIG. 7. In at least one embodiment, a trained machine learning model may be referred to as an output model 616, and may be used by deployment system 606, as described herein.

In at least one embodiment, training pipeline(s) 704 (FIG. 7) may include a scenario where facility 602 needs a machine learning model for use in performing one or more processing tasks for one or more applications in deployment system 606, but facility 602 may not currently have such a machine learning model (or may not have a model that is optimized, efficient, or effective for such purposes). In at least one embodiment, an existing machine learning model may be selected from model registry 624. In at least one embodiment, model registry 624 may include machine learning models trained to perform a variety of different inference tasks on imaging data. In at least one embodiment, machine learning models in model registry 624 may have been trained on imaging data from different facilities than facility 602 (e.g., facilities that are remotely located). In at least one embodiment, machine learning models may have been trained on imaging data from one location, two locations, or any number of locations. In at least one embodiment, when being trained on imaging data, which may be a form of feedback data 608, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained – or partially trained – at one location, a machine learning model may be added to model registry 624. In at least one embodiment, a machine learning model may then be retrained, or updated, at any number of other facilities, and a retrained or updated model may be made available in model registry 624. In at least one embodiment, a machine learning model may then be selected from model registry 624 – and referred to as output model(s) 616– and may be used in deployment system 606 to perform one or more processing tasks for one or more applications of a deployment system.

In at least one embodiment, training pipeline(s) 704 (FIG. 7) may be used in a scenario that includes facility 602 requiring a machine learning model for use in performing one or more processing tasks for one or more applications in deployment system 606, but facility 602 may not currently have such a machine learning model (or may not have a model that is optimized, efficient, or effective for such purposes). In at least one embodiment, a machine learning model selected from model registry 624 might not be fine-tuned or optimized for feedback data 608 generated at facility 602 because of differences in populations, genetic variations, robustness of training data used to train a machine learning model, diversity in anomalies of training data, and/or other issues with training data. In at least one embodiment, AI-assisted annotation 610 may be used to aid in generating annotations corresponding to feedback data 608 to be used as ground truth data for retraining or updating a machine learning model. In at least one embodiment, labeled data 612 may be used as ground truth data for training a machine learning model. In at least one embodiment, retraining or updating a machine learning model may be referred to as model training 614. In at least one embodiment, model training 614 may include data – e.g., AI-assisted annotations 610, labeled data 612, or a combination thereof – that may be used as ground truth data for retraining or updating a machine learning model.

In at least one embodiment, deployment system 606 may include software 618, service 620, hardware 622, and/or other components, features, and functionality. In at least one embodiment, deployment system 606 may include a software “stack,” such that software 618 may be built on top of service 620 and may use service 620 to perform some or all of processing tasks, and service 620 and software 618 may be built on top of hardware 622 and use hardware 622 to execute processing, storage, and/or other compute tasks of deployment system 606.

In at least one embodiment, software 618 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 608 (or other data types, such as those described herein). In at least one embodiment, an advanced processing and inferencing pipeline may be defined based on selections of different containers that are desired or required for processing feedback data 608, in addition to containers that receive and configure imaging data for use by each container and/or for use by facility 602 after processing through a pipeline (e.g., to convert outputs back to a usable data type for storage and display at facility 602). In at least one embodiment, a combination of containers within software 618 (e.g., that make up a pipeline) may be referred to as a virtual instrument (as described in more detail herein), and a virtual instrument may leverage service 620 and hardware 622 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 616 of training system 604.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 624 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 620 as a system (e.g., computer system 700 of FIG. 7). In at least one embodiment, once validated by computer system 700 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., computer system 700 of FIG. 7). In at least one embodiment, completed and validated applications or containers may be stored in a container registry and associated machine learning models may be stored in model registry 624. In at least one embodiment, a requesting entity that provides an inference or image processing request may browse a container registry and/or model registry 624 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 606 (e.g., a cloud) to perform processing of a data processing pipeline. In at least one embodiment, processing by deployment system 606 may include referencing selected elements (e.g., applications, containers, models, etc.) from a container registry and/or model registry 624. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 620 may be leveraged. In at least one embodiment, service 620 may include compute services, collaborative content creation services, simulation services, artificial intelligence (AI) services, visualization services, and/or other service types. In at least one embodiment, service 620 may provide functionality that is common to one or more applications in software 618, so functionality may be abstracted to a service that may be called upon or leveraged by applications. In at least one embodiment, functionality provided by service 620 may run dynamically and more efficiently, while also scaling well by allowing applications to process data in parallel, e.g., using a parallel computing platform 730 (FIG. 7). In at least one embodiment, rather than each application that shares a same functionality offered by a service 620 being required to have a respective instance of service 620, service 620 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 620 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 618 implementing advanced processing and inferencing pipeline may be streamlined because each application may call upon the same inference service to perform one or more inferencing tasks.

In at least one embodiment, hardware 622 may include GPUs, CPUs, data processing units (DPUs), an AI/deep learning system (e.g., an AI supercomputer, such as NVIDIA’s DGX^{TM} supercomputer system), a cloud platform, or a combination thereof. In at least one embodiment, different types of hardware 622 may be used to provide efficient, purpose-built support for software 618 and service 620 in deployment system 606. In at least one embodiment, use of GPU processing may be implemented for processing locally (e.g., at facility 602), within an AI/deep learning system, in a cloud system, and/or in other processing components of deployment system 606 to improve efficiency, accuracy, and efficacy of game name recognition.

In at least one embodiment, software 618 and/or service 620 may be optimized for GPU processing with respect to deep learning, machine learning, and/or high-performance computing, simulation, and visual computing, as non-limiting examples. In at least one embodiment, at least some of the computing environment of deployment system 606 and/or training system 604 may be executed in a datacenter or one or more supercomputers or high performance computing systems, with GPU-optimized software (e.g., hardware and software combination of NVIDIA’s DGX^{TM} system). In at least one embodiment, hardware 622 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA’s NGC^{TM}) may be executed using an AI/deep learning supercomputer(s) and/or GPU-optimized software (e.g., as provided on NVIDIA’s DGX^{TM} systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 7 is a system diagram for an example computer system 700 for generating and deploying a deployment pipeline, according to at least one embodiment. In at least one embodiment, computer system 700 may be used to implement process 600 of FIG. 6 and/or other processes including advanced processing and inferencing pipelines. In at least one embodiment, computer system 700 may include training system 604 and deployment system 606. In at least one embodiment, training system 604 and deployment system 606 may be implemented using software 618, services 620, and/or hardware 622, as described herein.

In at least one embodiment, computer system 700 (e.g., training system 604 and/or deployment system 606) may implemented in a cloud computing environment (e.g., using cloud 726). In at least one embodiment, computer system 700 may be implemented locally with respect to a facility, or as a combination of both cloud and local computing resources. In at least one embodiment, access to APIs in cloud 726 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of computer system 700, may be restricted to a set of public internet service providers (ISPs) that have been vetted or authorized for interaction.

In at least one embodiment, various components of computer system 700 may communicate between and among one another using any of a variety of different network types, including but not limited to local area networks (LANs) and/or wide area networks (WANs) via wired and/or wireless communication protocols. In at least one embodiment, communication between facilities and components of computer system 700 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 604 may execute training pipelines 704, similar to those described herein with respect to FIG. 6. In at least one embodiment, where one or more machine learning models are to be used in deployment pipeline(s) 710 by deployment system 606, training pipeline(s) 704 may be used to train or retrain one or more (e.g., pre-trained) models, and/or implement one or more of pre-trained models 706 (e.g., without a need for retraining or updating). In at least one embodiment, as a result of training pipeline(s) 704, output model(s) 616 may be generated. In at least one embodiment, training pipeline(s) 704 may include any number of processing steps, AI-assisted annotation 610, labeling or annotating of feedback data 608 to generate labeled data 612, model selection from a model registry, model training 614, training, retraining, or updating models, and/or other processing steps. In at least one embodiment, DICOM adapter 702a can be used to access DICOM data. In at least one embodiment, for different machine learning models used by deployment system 606, different training pipeline(s) 704 may be used. In at least one embodiment, training pipeline(s) 704, similar to a first example described with respect to FIG. 6, may be used for a first machine learning model, training pipeline(s) 704, similar to a second example described with respect to FIG. 6, may be used for a second machine learning model, and training pipeline(s) 704, similar to a third example described with respect to FIG. 6, may be used for a third machine learning model. In at least one embodiment, any combination of tasks within training system 604 may be used depending on what is required for each respective machine learning model. In at least one embodiment, one or more of machine learning models may already be trained and ready for deployment so machine learning models may not undergo any processing by training system 604 and may be implemented by deployment system 606.

In at least one embodiment, output model(s) 616 and/or pre-trained models 706 may include any types of machine learning models depending on embodiment. In at least one embodiment, and without limitation, machine learning models used by computer system 700 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 704 may include AI-assisted annotation. In at least one embodiment, labeled data 612 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 608 (or other data type used by machine learning models), there may be corresponding ground truth data generated by training system 604. In at least one embodiment, AI-assisted annotation may be performed as part of deployment pipeline(s) 710; either in addition to, or in lieu of, AI-assisted annotation included in training pipeline(s) 704. In at least one embodiment, computer system 700 may include a multi-layer platform that may include a software layer (e.g., software 618) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 602. In at least one embodiment, applications may then call or execute one or more services 620 for performing compute, AI, or visualization tasks associated with respective applications, and software 618 and/or services 620 may leverage hardware 622 to perform processing tasks in an effective and efficient manner.

In at least one embodiment, deployment system 606 may execute deployment pipelines 710. In at least one embodiment, deployment pipeline(s) 710 may include any number of applications that may be sequentially, non-sequentially, or otherwise applied to feedback data (and/or other data types), including AI-assisted annotation, as described above. In at least one embodiment, as described herein, a deployment pipeline(s) 710 for an individual device may be referred to as a virtual instrument for a device. In at least one embodiment, for a single device, there may be more than one deployment pipeline(s) 710 depending on information desired from data generated by a device.

In at least one embodiment, applications available for deployment pipeline(s) 710 may include any application that may be used for performing processing tasks on feedback data or other data from devices. In at least one embodiment, because various applications may share common image operations, in some embodiments, a data augmentation library (e.g., as one of services 620) may be used to accelerate these operations. In at least one embodiment, to avoid bottlenecks of conventional processing approaches that rely on CPU processing, parallel computing platform 730 may be used for GPU acceleration of these processing tasks.

In at least one embodiment, deployment system 606 may include a user interface (UI) 714 (e.g., a graphical user interface, a web interface, etc.) that may be used to select applications for inclusion in deployment pipeline(s) 710, arrange applications, modify or change applications or parameters or constructs thereof, use and interact with deployment pipeline(s) 710 during set-up and/or deployment, and/or to otherwise interact with deployment system 606. In at least one embodiment, although not illustrated with respect to training system 604, UI 714 (or a different user interface) may be used for selecting models for use in deployment system 606, for selecting models for training, or retraining, in training system 604, and/or for otherwise interacting with training system 604.

In at least one embodiment, pipeline manager 712 may be used, in addition to an application orchestration system 728, to manage interaction between applications or containers of deployment pipeline(s) 710 and services 620 and/or hardware 622. In at least one embodiment, pipeline manager 712 may be configured to facilitate interactions from application to application, from application to service 620, and/or from application or service to hardware 622. In at least one embodiment, although illustrated as included in software 618, this is not intended to be limiting, and in some examples pipeline manager 712 may be included in services 620. In at least one embodiment, application orchestration system 728 (e.g., Kubernetes, DOCKER, etc.) may include a container orchestration system that may group applications into containers as logical units for coordination, management, scaling, and deployment. In at least one embodiment, by associating applications from deployment pipeline(s) 710 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 712 and application orchestration system 728. In at least one embodiment, so long as an expected input and/or output of each container or application is known by a system (e.g., based on constructs of applications or containers), application orchestration system 728 and/or pipeline manager 712 may facilitate communication among and between, and sharing of resources among and between, each of the applications or containers. In at least one embodiment, because one or more of applications or containers in deployment pipeline(s) 710 may share the same services and resources, application orchestration system 728 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 728) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 620 leveraged and shared by applications or containers in deployment system 606 may include compute service(s) 716, collaborative content creation service(s) 717, AI service(s) 718, simulation service(s) 719, visualization service(s) 720, and/or other service types. In at least one embodiment, applications may call (e.g., execute) one or more of services 620 to perform processing operations for an application. In at least one embodiment, compute service(s) 716 may be leveraged by applications to perform super-computing or other high-performance computing (HPC) tasks. In at least one embodiment, compute service(s) 716 may be leveraged to perform parallel processing (e.g., using a parallel computing platform 730) for processing data through one or more of applications and/or one or more tasks of a single application, substantially simultaneously. In at least one embodiment, parallel computing platform 730 (e.g., NVIDIA’s CUDA^{®}) may enable general purpose computing on GPUs (GPGPU) (e.g., GPUs/graphics 722). In at least one embodiment, a software layer of parallel computing platform 730 may provide access to virtual instruction sets and parallel computational elements of GPUs, for execution of compute kernels. In at least one embodiment, parallel computing platform 730 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 730 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 718 may be leveraged to perform inferencing services for executing machine learning model(s) associated with applications (e.g., tasked with performing one or more processing tasks of an application). In at least one embodiment, AI service(s) 718 may leverage AI system(s) 724 to execute machine learning model(s) (e.g., neural networks, such as CNNs) for segmentation, reconstruction, object detection, feature detection, classification, and/or other inferencing tasks. In at least one embodiment, applications of deployment pipeline(s) 710 may use one or more of output model(s) 616 from training system 604 and/or other models of applications to perform inference on imaging data (e.g., DICOM data, RIS data, CIS data, REST compliant data, RPC data, raw data, etc.). For example, DICOM adapter 702b may be used to access DICOM data. In at least one embodiment, two or more examples of inferencing using application orchestration system 728 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 728 may distribute resources (e.g., services 620 and/or hardware 622) based on priority paths for different inferencing tasks of AI service(s) 718.

In at least one embodiment, shared storage may be mounted to AI service(s) 718 within computer system 700. In at least one embodiment, shared storage may operate as a cache (or other storage device type) and may be used to process inference requests from applications. In at least one embodiment, when an inference request is submitted, a request may be received by a set of API instances of deployment system 606, and one or more instances may be selected (e.g., for best fit, for load balancing, etc.) to process a request. In at least one embodiment, to process a request, a request may be entered into a database, a machine learning model may be located from model registry 624 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 712) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 620 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 726, and an inference service may perform inferencing on a GPU.

In at least one embodiment, visualization service(s) 720 may be leveraged to generate visualizations for viewing outputs of applications and/or deployment pipeline(s) 710. In at least one embodiment, GPUs/graphics 722 may be leveraged by visualization service(s) 720 to generate visualizations. In at least one embodiment, rendering effects, such as ray-tracing or other light transport simulation techniques, may be implemented by visualization service(s) 720 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 720 may include an internal visualizer, cinematics, and/or other rendering or image processing capabilities or functionality (e.g., ray tracing, rasterization, internal optics, etc.).

In at least one embodiment, hardware 622 may include GPUs/graphics 722, AI system(s) 724, cloud 726, and/or any other hardware used for executing training system 604 and/or deployment system 606. In at least one embodiment, GPUs/graphics 722 (e.g., NVIDIA’s TESLA^{®} and/or QUADRO^{®} GPUs) may include any number of GPUs that may be used for executing processing tasks of compute service(s) 716, collaborative content creation service(s) 717, AI service(s) 718, simulation service(s) 719, visualization service(s) 720, other services, and/or any of features or functionality of software 618. For example, with respect to AI service(s) 718, GPUs/graphics 722 may be used to perform pre-processing on imaging data (or other data types used by machine learning models), post-processing on outputs of machine learning models, and/or to perform inferencing (e.g., to execute machine learning models). In at least one embodiment, cloud 726, AI system(s) 724, and/or other components of computer system 700 may use GPUs/graphics 722. In at least one embodiment, cloud 726 may include a GPU-optimized platform for deep learning tasks. In at least one embodiment, AI system(s) 724 may use GPUs, and cloud 726 – or at least a portion tasked with deep learning or inferencing – may be executed using one or more AI system(s)s 724. As such, although hardware 622 is illustrated as discrete components, this is not intended to be limiting, and any components of hardware 622 may be combined with, or leveraged by, any other components of hardware 622.

In at least one embodiment, AI system(s) 724 may include a purpose-built computing system (e.g., a super-computer or an HPC) configured for inferencing, deep learning, machine learning, and/or other artificial intelligence tasks. In at least one embodiment, AI system(s) 724 (e.g., NVIDIA’s DGX^{TM}) may include GPU-optimized software (e.g., a software stack) that may be executed using a plurality of GPUs/graphics 722, in addition to CPUs, RAM, storage, and/or other components, features, or functionality. In at least one embodiment, one or more AI system(s)s 724 may be implemented in cloud 726 (e.g., in a data center) for performing some or all of AI-based processing tasks of computer system 700.

In at least one embodiment, cloud 726 may include a GPU-accelerated infrastructure (e.g., NVIDIA’s NGC^{TM}) that may provide a GPU-optimized platform for executing processing tasks of computer system 700. In at least one embodiment, cloud 726 may include an AI system(s) 724 for performing one or more of AI-based tasks of computer system 700 (e.g., as a hardware abstraction and scaling platform). In at least one embodiment, cloud 726 may integrate with application orchestration system 728 leveraging multiple GPUs to enable seamless scaling and load balancing between and among applications and services 620. In at least one embodiment, cloud 726 may be tasked with executing at least some of services 620 of computer system 700, including compute service(s) 716, AI service(s) 718, and/or visualization service(s) 720, as described herein. In at least one embodiment, cloud 726 may perform small and large batch inference (e.g., executing NVIDIA’s TensorRT^{TM}), provide an accelerated parallel computing platform 730 (e.g., NVIDIA’s CUDA^{®}), execute application orchestration system 728 (e.g., KUBERNETES), provide a graphics rendering API and platform (e.g., for ray-tracing, 2D graphics, 3D graphics, and/or other rendering techniques to produce higher quality cinematics), and/or may provide other functionality for computer system 700. In at least one embodiment, parallel computing platform 730 may include an API.

In at least one embodiment, in an effort to preserve patient confidentiality (e.g., where patient data or records are to be used off-premises), cloud 726 may include a registry, such as a deep learning container registry. In at least one embodiment, a registry may store containers for instantiations of applications that may perform pre-processing, post-processing, or other processing tasks on patient data. In at least one embodiment, cloud 726 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

### NEURAL NETWORK TRAINING AND DEPLOYMENT

FIG. 8 is a block diagram illustrating an exemplary computer system 800, which may be a system with interconnected devices and components, a system-on-a-chip (SOC) or some combination thereof formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, XeonTM, Itanium®, XScaleTM and/or StrongARMTM, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS’ operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment, computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs.

In at least one embodiment, processor 802 may include, without limitation, a Level 2 (“L2”) internal cache memory (“cache”) 804. The L2 cache can serve as a secondary, larger, and somewhat slower cache compared to the L1 cache that is still faster than accessing the main memory (e.g., via the memory controller hub 816). Thus, the L2 cache can enhance performance by reducing the time the processor spends accessing the main memory. In at least one embodiment, processor 802 may have a single internal L2 cache or multiple levels of internal cache. In embodiments where the processor 802 is a multi-core processor, the L2 cache can be shared among multiple cores of processor 802, providing a larger, intermediate level of cache memory for more than one processor core. In at least one embodiment, L2 cache memory may reside external to processor 802.

In at least one embodiment, processor 802 may include, without limitation, a Level 3 (“L3”) internal cache memory (“cache”) 804. The L3 cache can serve as a tertiary, larger, and slower cache compared to both the L1 and L2 caches. The L3 cache can enhance performance by reducing the time the processor spends accessing the main memory. The L3 cache can be shared among multiple cores of processor 802, providing a larger pool of fast-access memory for data for the processor cores. In at least one embodiment, processor 802 may have a single internal L3 cache or multiple levels of internal cache. In at least one embodiment, L3 cache memory may reside external to processor 802. Other embodiments may also include any combination of internal or external L1, L2, and/or L3 caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating point operations, also resides in processor 802. In at least one embodiment, processor 802 may also include a microcode (“ucode”) read only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor’s data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interfaces 825, a serial expansion port 827, such as Universal Serial Bus (“USB”), and a network controller 834, which may include in some embodiments, a data processing unit. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips”, whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects.

Inference and/or training logic 815 are used to perform inferencing and/or training operations associated with one or more embodiments. The inference and/or training logic 815 may include same or similar features of training logic/hardware structure(s) 415. Details training logic/hardware structure(s) 415 are provided in conjunction with FIG. 4A and/or FIG. 4B. In at least one embodiment, inference and/or training logic 815 may be used in system FIG. 8 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

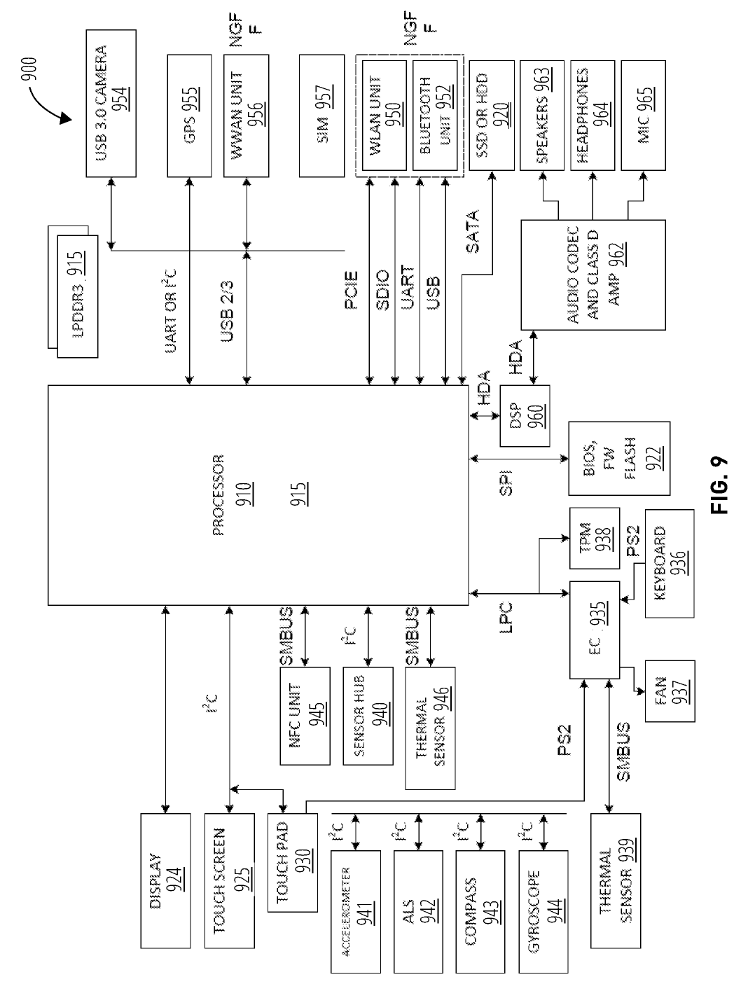

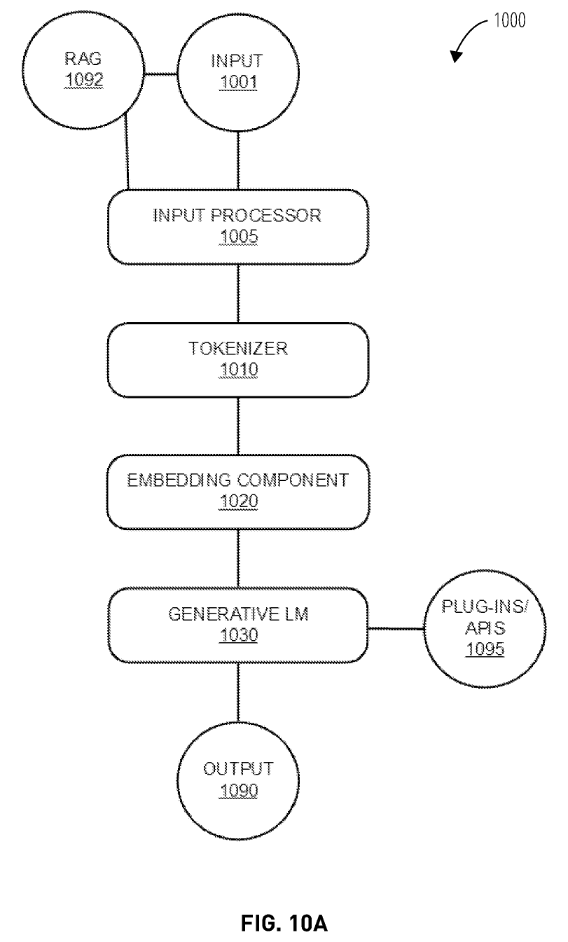

FIG. 9 is a block diagram illustrating an electronic device 900 for utilizing a processor 910, according to at least one embodiment. In at least one embodiment, electronic device 900 may be, for example and without limitation, a notebook, a tower server, a rack server, a blade server, a laptop, a desktop, a tablet, a mobile device, a phone, an embedded computer, an edge device, an IoT device, or any other suitable electronic device.

In at least one embodiment, electronic device 900 may include, without limitation, processor 910 communicatively coupled to any suitable number or kind of components, peripherals, modules, or devices. In at least one embodiment, processor 910 coupled using a bus or interface, such as a I2C bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices illustrated in FIG. 9 may be interconnected with proprietary interconnects, standardized interconnects (e.g., PCIe) or some combination thereof. In at least one embodiment, one or more components of FIG. 9 are interconnected using compute express link (CXL) interconnects.

In at least one embodiment, FIG. 9 may include a display 924, a touch screen 925, a touch pad 930, a Near Field Communications unit (“NFC”) 945, a sensor hub 940, a thermal sensor 946, an Express Chipset (“EC”) 935, a Trusted Platform Module (“TPM”) 938, BIOS/firmware/flash memory (“BIOS, FW Flash”) 922, a DSP 960, a drive 920 such as a Solid State Disk (“SSD”) or a Hard Disk Drive (“HDD”), a wireless local area network unit (“WLAN”) 950, a Bluetooth unit 952, a Wireless Wide Area Network unit (“WWAN”) 956, a Global Positioning System (GPS) 955, a camera (“USB 3.0 camera”) 954 such as a USB 3.0 camera, and/or a Low Power Double Data Rate (“LPDDR”) memory unit (“LPDDR3”) 915 implemented in, for example, LPDDR3 standard. These components may each be implemented in any suitable manner.

In at least one embodiment, other components may be communicatively coupled to processor 910 through components discussed above. In at least one embodiment, an accelerometer 941, Ambient Light Sensor (“ALS”) 942, compass 943, and a gyroscope 944 may be communicatively coupled to sensor hub 940. In at least one embodiment, thermal sensor 939, a fan 937, a keyboard 936, and a touch pad 930 may be communicatively coupled to EC 935. In at least one embodiment, speaker 963, headphones 964, and microphone (“mic”) 965 may be communicatively coupled to an audio unit (“audio codec and class d amp”) 962, which may in turn be communicatively coupled to DSP 960. In at least one embodiment, audio unit 962 may include, for example and without limitation, an audio coder/decoder (“codec”) and a class D amplifier. In at least one embodiment, SIM card (“SIM”) 957 may be communicatively coupled to WWAN unit 956. In at least one embodiment, components such as WLAN unit 950 and Bluetooth unit 952, as well as WWAN unit 956 may be implemented in a Next Generation Form Factor (“NGFF”).

Inference and/or training logic/hardware structures 415 are used to perform inferencing and/or training operations associated with one or more embodiments. Details regarding training logic/hardware structure(s) 415 are provided in conjunction with FIG. 4A and/or FIG. 4B. In at least one embodiment, inference and/or training logic structures 415 may be used in system FIG. 9 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

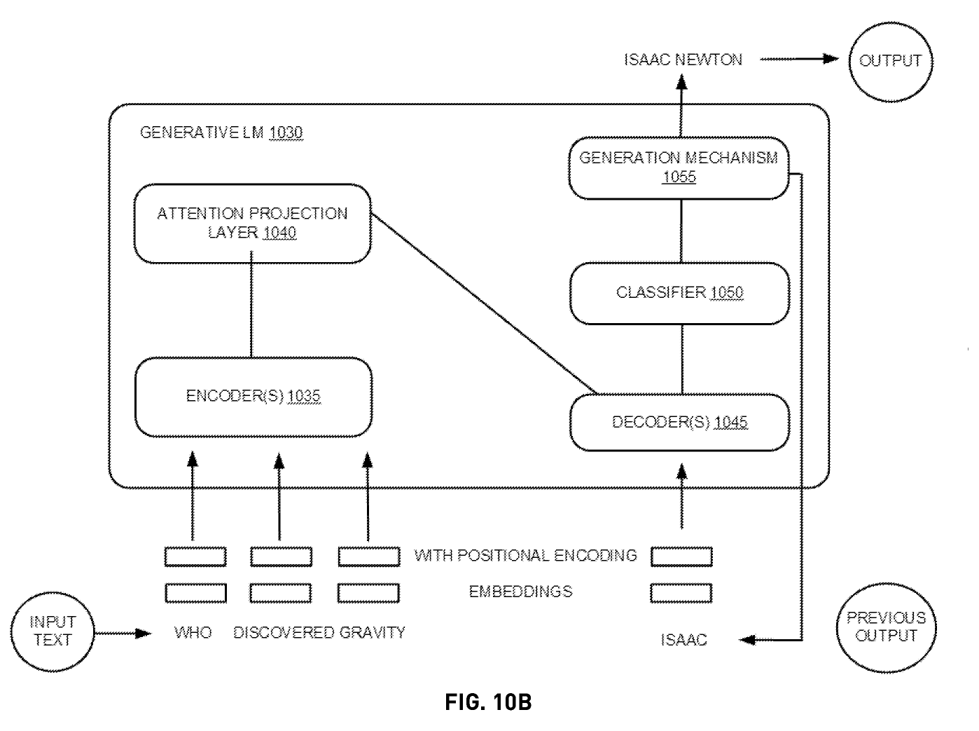

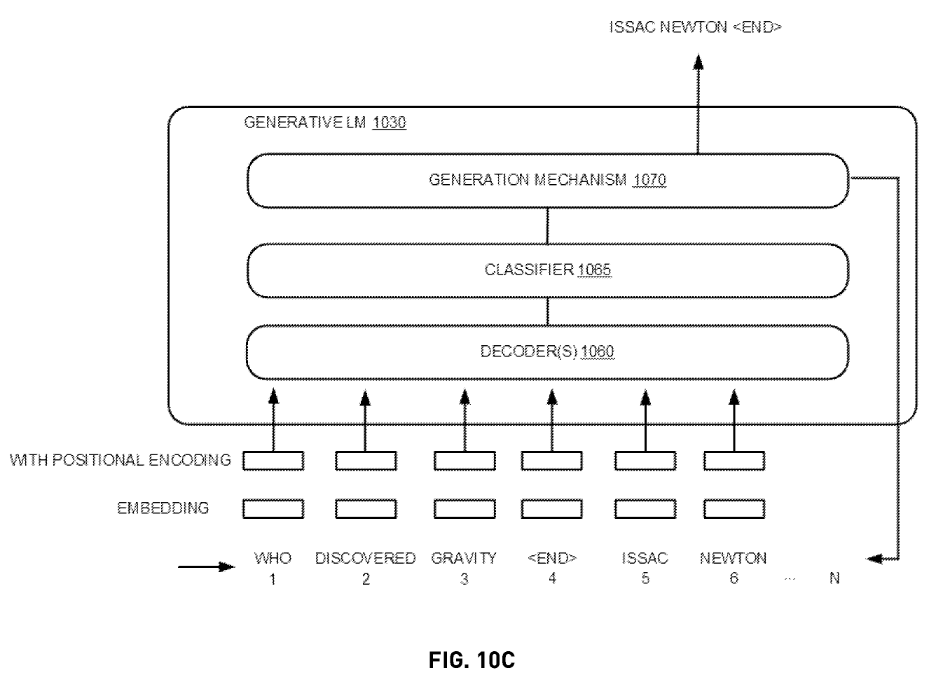

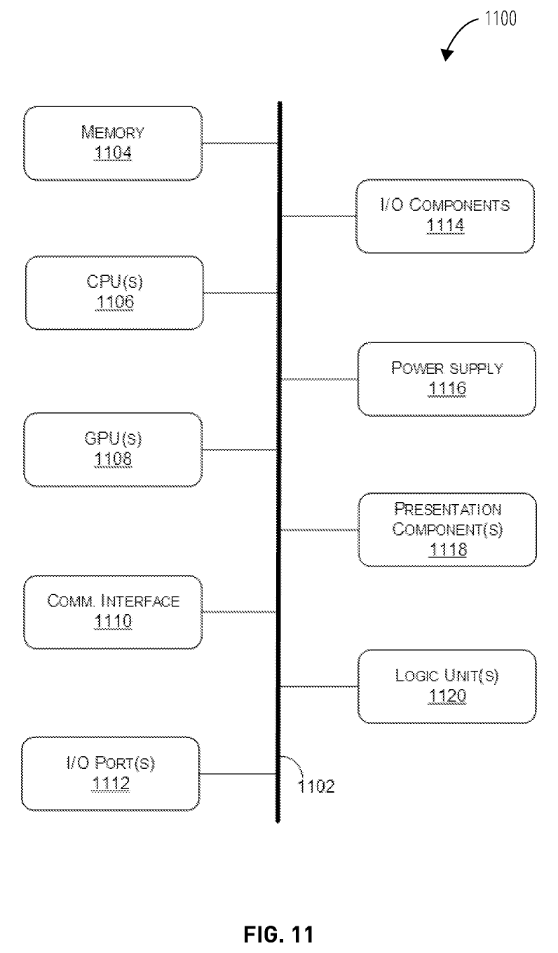

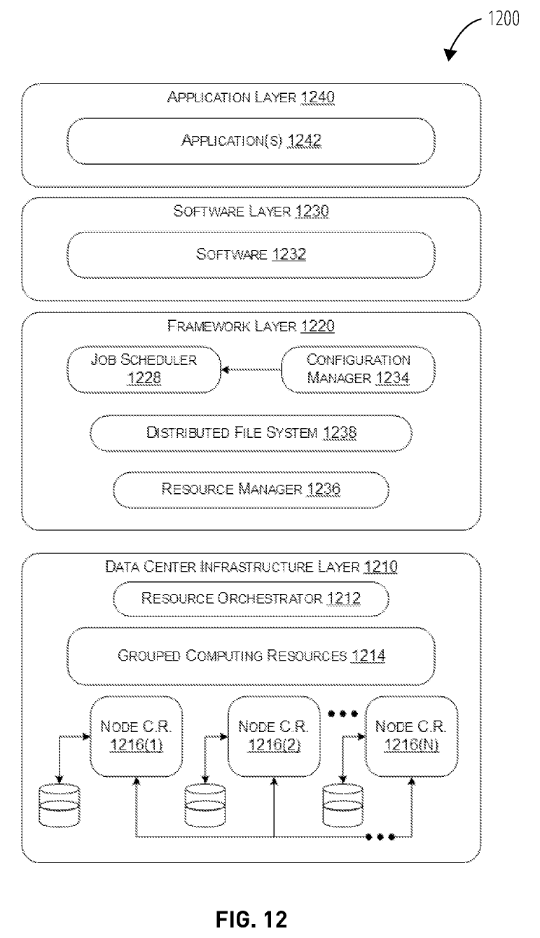

With reference to FIG. 1, FIG. 1 is an example … , in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. For example, in some embodiments, the system and methods described herein may be implemented using one or more generative language models (e.g., as described in FIGS. 10A-10C), one or more computing devices (e.g., as described in FIG. 11), and/or one or more data centers (e.g., as described in FIG. 12).

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models – such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as Open-USD, and/or other data types), systems implemented at least partially using cloud computing resources, and/or other types of systems.

### EXAMPLE LANGUAGE MODELS

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases) – such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, and/or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

In some embodiments, the systems and methods described herein may be performed within a simulation environment (e.g., NVIDIA’s DriveSIM) using simulated data (e.g., simulated sensor data of simulated sensors of a virtual or simulated machine). For example, simulated sensor data and/or map data may be used to identify regions of interest (e.g., parking spaces) and sub-regions of interest (e.g., sub-regions of a parking space that includes a curb, wheel stop, etc.) within the simulation environment, and may use this information to perform operations (e.g., parking) associated with the virtual machine within the environment. These simulated operations may be used to test performance of the underlying algorithms, systems, and/or processes prior to deploying them in the real-world. In some instances, the simulation may be used to generate synthetic training data – e.g., training data including regions of interest and/or sub-regions of interest from within the simulation. The synthetic training data (in addition to or alternatively from real-world data) may then be processed to determine geometry and/or other information related to regions of interest, such as parking spaces or pallet delivery locations within a warehouse, for example. In any example, such as where a simulation environment is used for testing, validation, training, etc., the simulation environment and/or associated training data may be rendered or otherwise generated using one or more light transport algorithms – such as ray-tracing and/or path-tracing algorithms. In some embodiments, the simulation environment and/or one or more objects, features, or components thereof may be generated or managed within a three-dimensional (3D) content collaboration platform (e.g., NVIDIA’s OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA’s PhysX SDK, in order to simulate real physics and physical interactions with simulations hosted by the platform. The platform may integrate OpenUSD along with ray tracing/path tracing/light transport simulation (e.g., NVIDIA’s RTX rendering technologies) into software tools and simulation workflows for building, training, deploying, or testing AI systems – such as systems for testing, validating, training (e.g., machine learning models, neural networks, etc.), and/or other tasks related to automotive, robot, machine, or other applications.

Various types of LLM/VLM/etc. architectures may be implemented in various embodiments. For example, different architectures may be implemented that use different techniques for understanding and generating outputs – such as text, audio, video, image, etc. In some embodiments, LLM architectures such as recurrent neural networks (RNNs) or long short-term memory networks (LSTMs) may be used, while in other embodiments transformer architectures – such as those that rely on self-attention mechanisms – may be used to understand and recognize relationships between words or tokens. One or more generative processing pipelines that include LLMs may also include one or more diffusion block(s) (e.g., denoisers). The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type – including but not limited to those described herein – may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. Pat. App. No. 18,304,341, filed on April 20, 2023, the contents of which are hereby incorporated by reference in their entirety. In some embodiments, one or more additional models – or layers thereof – may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/etc. of the present disclosure may be less likely to output language/text/audio/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated – e.g., recursively – for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources – such as APIs, plug-ins, and/or the like.

In some embodiments, multiple language models (e.g., LLMs/VLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents – e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc. – as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model – or version, instance, or agent – maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 10A is a block diagram of an example generative language model system 1000 suitable for use in implementing at least some embodiments of the present disclosure. In the example illustrated in FIG. 10A, the generative language model system 1000 includes a retrieval augmented generation (RAG) component 1092, an input processor 1005, a tokenizer 1010, an embedding component 1020, plug-ins/APIs 1095, and a generative language model (LM) 1030 (which may include an LLM, a VLM, a multi-modal LM, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 1030. In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multimodal inputs, the input 1001 may combine text with image data, audio data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1092 may be used to retrieve additional information to be used as part of the input 1001 or prompt. For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve – using a vector search in an embedding space, for example – the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history – or at least a summary thereof – and include the prior conversation history along with the current ask/request as part of the input 1001 to the generative LM 1030.

The tokenizer 1010 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data, the input processor 1001 may resize the image data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features – such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multimodal data, the embedding component 1020 may fuse representations of the different types of data (e.g., text, image, audio) using techniques like early fusion (concatenation), late fusion (sequential processing), attention-based fusion, etc.

The generative LM 1030 and/or other components of the generative LLM system 1000 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use – or capable of accessing or using – plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated – e.g., recursively – for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources – such as the plug-ins/APIs 1095.

FIG. 10B is a block diagram of an example implementation in which the generative LM 1030 includes a transformer encoder-decoder. For example, assume input text such as “Who discovered gravity” is tokenized (e.g., by the tokenizer1010 of FIG. 10A) into tokens such as words, and each token is encoded (e.g., by the embedding component 1020 of FIG. 910A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1035 of the generative LM 1030.

In an example implementation, the encoder(s) 1035 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1040 may convert the context vector into attention vectors (keys and values) for the decoder(s) 1045.

In an example implementation, the decoder(s) 1045 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1035, in an example transformer architecture, each token (e.g., word) flows through a separate path in the decoder(s) 1045. During a first pass, the decoder(s) 1045, a classifier 1050, and a generation mechanism 1055 may generate a first token, and the generation mechanism 1055 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1045 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1035, except that it creates its queries from the layer below it and takes the keys and values (e.g., matrix) from the output of the encoder(s) 1035.

As such, the decoder(s) 1045 may output some decoded (e.g., vector) representation of the input being applied during a particular pass. The classifier 1050 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1055 may select or sample a word or token based on a corresponding predicted probability (e.g., select the word with the highest predicted probability) and append it to the output from a previous pass, generating each word or token sequentially. The generation mechanism 1055 may repeat the process, triggering successive decoder inputs and corresponding predictions until selecting or sampling a symbol or token that represents the end of the response, at which point, the generation mechanism 1055 may output the generated response.

FIG. 10C is a block diagram of an example implementation in which the generative LM 1030 includes a decoder-only transformer architecture. For example, the decoder(s) 1060 of FIG. 10C may operate similarly as the decoder(s) 1045 of FIG. 10B except each of the decoder(s) 1060 of FIG. 10C omits the encoder-decoder self-attention layer (since there is no encoder in this implementation). As such, the decoder(s) 1060 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1060. As with the decoder(s) 1045 of FIG. 10B, each token (e.g., word) may flow through a separate path in the decoder(s) 1060, and the decoder(s) 1060, a classifier 1065, and a generation mechanism 1070 may use auto-regression to sequentially generate one token at a time until predicting a symbol or token that represents the end of the response. The classifier 1065 and the generation mechanism 1070 may operate similarly as the classifier 1050 and the generation mechanism 1055 of FIG. 10B, with the generation mechanism 1070 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### EXAMPLE COMPUTING DEVICE

FIG. 11 is a block diagram of an example computing device(s) 1100 suitable for use in implementing some embodiments of the present disclosure. The example computing device 1100 may include one or more of the features of the computer system 100 as described above with respect to FIG. 1. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs) – which may include one or more direct memory access (DMA) systems, one or more vision or vector processing units (VPUs), one or more pixel processing engines (PPEs), one or more decoupled accelerators (e.g., decoupled lookup table (DLUT) accelerators), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### EXAMPLE DATA CENTER

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-1216(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark^{TM} (hereinafter “Spark”) that may use distributed file system 1238 for large-scale data processing (e.g., "big data"). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11 – e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments – in which case a server may not be included in a network environment – and one or more client-server network environments – in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., "big data").

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors — for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system’s registers and/or memories into other data similarly represented as physical quantities within computing system’s memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
allocating a first portion of a shared processor cache of a multi-core processor for a first task; and
restricting additional tasks from writing to the first portion of the shared processor cache.

2. The method of claim 1, wherein allocating the first portion of the shared processor cache for the first task comprises:
assigning the first portion of the shared processor cache to a first class of service (CoS);
assigning a first processor core of the multi-core processor to the first CoS; and
assigning the first processor core to the first task.

3. The method of claim 2, further comprising:
restricting the first processor core from performing the additional tasks.

4. The method of claim 2, wherein assigning the first portion of the shared processor cache and the first processor core to the first CoS restricts additional processor cores of the multi-core processor from performing the first task, wherein the additional processor cores are not assigned to the first CoS.

5. The method of claim 1, wherein restricting the additional tasks from writing to the first portion of the shared processor cache further comprises:
restricting a first subset of processor cores of the multi-core processor to processing a subset of tasks of a program comprising the first task; and
restricting a second subset of processor cores of the multi-core processor to processing the additional tasks, wherein processor cores of the second subset are restricted from writing to the first portion of the shared processor cache, and wherein the first and second subsets of processor cores do not share a same processor core.

6. The method of claim 1, further comprising:
loading the first portion of the shared processor cache with a dataset from a memory operatively coupled to the multi-core processor at a first time by a first processor core of the multi-core processor; and
performing, by the first processor core, the first task using the dataset as read from the shared processor cache at a second time.

7. The method of claim 1, further comprising:
partitioning, based on one or more characteristics of the shared processor cache, the shared processor cache into a plurality of cache blocks; and
assigning a first subset of the plurality of cache blocks to a first class of service (CoS), wherein the first portion of the shared processor cache comprises the first subset of the plurality of cache blocks, wherein the first task is associated with the first CoS.

8. The method of claim 7, wherein the first task is performed by a first processor core that is assigned to the first CoS.

9. The method of claim 7, further comprising:
assigning a second subset of the plurality of cache blocks to a second CoS, wherein a second portion of the shared processor cache that comprises the second subset of the plurality of cache blocks, and wherein the first and second subsets do not comprise a same cache block.

10. The method of claim 7, wherein the one or more characteristics of the shared processor cache comprises one or more of a granularity of resource management of the shared processor cache, a memory size of the shared processor cache, a cache line size of the shared processor cache, an associativity metric of the shared processor cache, or a number of cache sets within the shared processor cache.

11. The method of claim 7, wherein a number of cache blocks of the first subset is determined based on a size of a dataset corresponding to the first task, wherein the dataset is stored in main memory external to the multi-core processor.

12. The method of claim 1, further comprising receiving a user query for a retrieval-augmented generation (RAG) model corresponding to the first task, wherein the first task is a vector dataset retrieval task corresponding to the RAG model.

13. The method of claim 12, further comprising:
determining that the first portion of the shared processor cache comprises sufficient memory space large enough to concurrently store all of a vector dataset corresponding to the vector dataset retrieval task;
loading all of the vector dataset into the first portion of the shared processor cache; and
locking the first portion of the shared processor cache so as to prevent evictions from the cache of the vector dataset from the first portion of the shared processor cache.

14. A device comprising:
a processor comprising a shared processor cache; and
a memory storing instructions that, when executed by the processor, configure the device to:
partition the shared processor cache to include at least a first portion; and
allocate the first portion of the shared processor cache for a first task, wherein additional tasks are restricted from performing at least one specific type of access to the first portion of the shared processor cache.

15. The device of claim 14, wherein to allocate the first portion of the shared processor cache for the first task, the instructions configure the device to:
assign the first portion of the shared processor cache to a first class of service (CoS); and
assign a first processor core of the processor to the first CoS; and
assign the first processor core to the first task.

16. The device of claim 15, wherein the instructions further configure the device to:
restrict the first processor core from performing the additional tasks.

17. The device of claim 15, wherein assigning the first portion of the shared processor cache and the first processor core to the first CoS restricts additional processor cores of the processor from performing the first task, wherein the additional processor cores are not assigned to the first CoS.

18. The device of claim 14, wherein to restrict the additional tasks from performing the at least one specific type of access to the first portion of the shared processor cache, the instructions configure the device to:
restrict a first subset of processor cores of the processor to processing a subset of tasks of a program comprising the first task; and
restrict a second subset of processor cores of the processor to processing the additional tasks, wherein the second subset of processor cores is restricted from performing the least one specific type of access to the first portion of the shared processor cache, and wherein the first and second subsets of processor cores do not share a same processor core.

19. The device of claim 14, wherein the instructions further configure the device to:
load the first portion of the shared processor cache with a dataset from a memory operatively coupled to the processor at a first time by a first processor core of the processor; and
perform, by the first processor core, the first task using the dataset as read from the shared processor cache at a second time.

20. At least one processor comprising:
processing circuitry to perform operations comprising:
receiving a request to begin program operations on a particular processor, the program operations corresponding to a program;
reserving a first segmented portion of a shared processor cache of the particular processor for tasks of a first type; and
reserving a second segmented portion of the shared processor cache for tasks of a second type, wherein tasks of the first type are restricted from performing at least one specific type of access to the second segmented portion and tasks of the second type are restricted from performing the at least one specific type of access to the first segmented portion.
